(19) United States
(12) Patent Application Publication
(10) Pub. No.: US 2010/0114864 A1
(43) Pub. Date: May 6, 2010

(54) METHOD AND SYSTEM FOR SEARCH ENGINE OPTIMIZATION

(76) Inventors: Leedor AGAM, Savyon (IL); Hen (Evgeny) Osipov, Ashkelon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/612,718

(22) Filed: Nov. 5, 2009

Related U.S. Application Data
(60) Provisional application No. 61/111,739, filed on Nov. 6, 2008.

(51) Int. Cl. G06F 17/30

(52) U.S. Cl. 707/709; 707/736; 707/E17.108; 707/706; 706/47; 707/713

(57) ABSTRACT

It is provided a method and system for optimizing multiple website pages for search engine presence and positioning. Rule data collections are constructed by a management engine which may be guided by a consultant. Page selection criteria may be associated with the rule data collections. A rule implementing application program applies page editing actions of the rule data collection on appropriate website pages, thus creating optimized website pages. Thus, it is provided automatic implementation of certain search engine optimization (SEO) operations on multiple website pages, decreasing page editing and programming work load SEO of consultants and website programmers.

### CROSS REFERENCE TO RELATED APPLICATIONS

The present application claims the priority benefits of provisional U.S. patent application No. 61/111,739 titled “Method and system for search engine optimization” filed Nov. 7, 2008, by the present inventors.

### BACKGROUND OF THE INVENTION

1. Field of the Invention

The present invention relates to search engine optimization (SEO) and, in particular, to a method and system for automation of operations which improve search engine presence and positioning.

2. Description of Related Art

US publication 2008/077556 to Muriente and US publication 2009/0006311 are incorporated herein by reference in its entirety and for all purposes. A search engine (e.g. Google, Yahoo!, MSN Search) is a software program hosted on Internet Web servers that indexes Web sites and Website pages on the World Wide Web, and allows end users and crawlers to search the index for websites and pages that match a search query. A search query may be a keyword or keyword phrase that includes Boolean logic (AND, OR, NOT, etc) or operators specific for the search engine.

From the viewpoint of an internet user, as the World Wide Web contains milliards of websites and website pages, search engines are a central tool for locating a interest. On the other hand, for success of their business, website owners and operators need to attract as many as possible relevant users to their sites, overcoming a fierce competition with other website of overlapping activity fields. To that aim, website owners have to build and or adapt their website such that search engines route as many as possible relevant users to their websites pages.

When a particular query is submitted to a search engine, the results are provided to the user in a sequential order, each result has a search engine position and ranking, whereas that position dramatically affects the user attraction to a specific website of the numerous websites that frequently appear in a result list. The search engine positioning is defined as the numeric position, or ranking in which a website page, or a document having another format, is included within a list of search engine results pages as a response to a user-generated query for a particular text keyword or keyword phrase, or a sentence or any other query. Based on its own proprietary evaluation criteria, each search engine determines the positioning and or ranking of website pages and documents contained within its index for each text keyword or keyword phrase. In order for a Website page or document to be eligible to be included and positioned within the list for a particular user query, the website page must be subjected to the search engine's algorithms for crawling, indexing, and ranking.

The position of a Website page, web data or Web-site at the result list may be improved by search engine optimization (SEO). SEO includes any technique applied to a website page or documents at other formats, website, digital content of any type, or website sub-section in order to:

a) Facilitate and improve the process of having a search engine crawl website pages or documents or any other technique that might be used in the future to locate a Web site faster, more often, more efficiently, in a more relevant way and more completely. Completeness means that higher percentage of the website pages are being crawled.
b) Improve the likelihood of having a search engine include web pages or documents in its search index, eligible to be returned within a list for various user generated search queries.
c) Increase the likelihood of having a Website page or document included (or ranked) for a particular keyword or keyword phrase, or any other query, and be ranked in a higher position as possible within the list responses to a query.

Having more website pages and documents included in the various search engine indices and ranking at higher positions, increases ranking position and generates more visitors from the search engine to the parent websites. Having higher levels of traffic or visitors to a website is an important factor for success. For example, in a website with advertisement as an income business model, viewers or readers are important similarly to their importance to traditional media, i.e. newspapers, television, and radio. To be more specific, in one advertisement (ad) compensation method (PPM—pay per mille) a media agency pays the website owner for certain ad in proportionality to the number of visitors exposed to that ad and/or the exposure time. In another common compensation method (PPC—pay per click) the media agency pays the website owner in proportionality to the number of visitors who have clicked a hyperlink embedded in the ad or other hyper linking means.

As another example, a virtual store website needs to attract visitors much alike conventional stores are preferentially located in malls having high shopper traffic.

SEO is an important segment of Search Engine Marketing (hereafter SEM). Other SEM method of generating traffic to Web sites is advertising in search engine result pages (e.g. Google AdWords). SEO is often considered in the community as more cost effective method than direct payment to the search engine for result list advertisement. Both direct payment for search words such as pay per click (PPC) and SEO can in general be considered as alternatives and or complementary methods to attract traffic and or visitors to a website.

Generally, the exact details of search engine crawling, ranking, and indexing algorithms represent proprietary information that is not generally or regularly disclosed by the various search engine companies. Furthermore, the search engine companies may modify and upgrade these algorithms periodically to improve the quality of results provided to users in response to their submitted search queries while preventing SEO experts from unfairly manipulating the search engine results. To this aim, SEO strategies are developed and adapted based on several sources:

a) Partial guideline information provided from time to time by search engine companies.
b) Trial and error results generated by testing various SEO strategies, achieving positive or negative results, and analyzing the results.
c) Untested theories given by SEO experts.
d) Interpretation of patent applications assigned to search engine companies.
e) Practices commonly discussed and supported in SEO forums.

SEO may be done by using language components supported by search engines, HTML meta tags and the robots.txt protocol, for example. More generally, a page may be modified by adding an element to a part of the page. The element may be a link, a piece of text, a keyword, a piece of meta data, and a layout. The page part may be a header, a footer, and a body of a page. Besides, a page or a whole website may be improved by having a link to it from another website, preferably a highly ranked website. Such a link may be obtained based on mutual link exchange with the other website, or buying links from other websites.

SEO consultant may use analytical tools provided by search engines or other web statistics providers to collect and present statistical data on visitors and their activities while visiting a website. For example, a consultant may find that visitors which followed a search for a specific keyword tend to stay more time on the website or conduct a shopping action. Consequently, the consultant optimizes certain website pages to make them highly ranked for that specific keyword.

As the number of static pages in a website increases, conducting SEO operations in each page necessitates a lot of design and programming which is a tedious, expensive and time consuming task. Thus, there is a need in the SEO community for automating SEO tasks.

### BRIEF SUMMARY OF THE INVENTION

It is provided for the first time a method for optimizing pages of several websites for search engine presence and positioning. The method includes configuring SEO rule data collection for application of SEO operations on website pages, transferring or retrieving the SEO rule data collection to the websites, and applying the SEO operation of the rule data collection on pages of several websites to get optimized pages. At least one SEO rule data collection includes at least one SEO operation which is appropriate for at least two websites. Thus, these at least two pages of two different websites are effected by one rule data collection.

In some embodiments the method further includes the steps of providing a management engine operative for configuring one or more Rules data collection, providing a rule-implementing application operative for the application of Rules data collection to a webpage or website as required.

In some embodiments the application of Rules data collection using the Rule-implementing application include instructions, parameters and data for page editing actions such as adding an element to a part of the page, changing, deleting or adding an element in a part of the page, and changing a parameter of the page. Exemplary elements or parameters are a link, a link index, a link pointer, a piece of text, a keyword, a piece of meta data, and a layout. Exemplary page parts are a header, a footer, a meta data part, and a body of a page.

In some embodiments the method further includes the steps of receiving page request from a page client, and generating a page responsive to page request. In one implementation, the rule-implementing application performs the changes to the generated pages, and the optimized pages are submitted to the page client. Generating a page may be copying all or part of a static page from a database associated with a website having the requested page. Generating a page may also be integrating a dynamic page from data items available in various databases, whereas the integrating is conducted in accordance with the page request. Exemplary page clients are a search engine crawler and a web browser.

It is provided for the first time a method for optimizing website pages for search engine presence and positioning. The method includes configuring SEO rule data collection for application of SEO operations on website pages, defining page selection criteria, transferring the rule data collection to the websites, and applying the SEO rule data collection using the rule-implementing application to the website pages to get optimized pages. This application is conducted provided that the pages comply with the page selection criteria, which may be associated with an applied rule.

In some embodiments, the page selection criteria include compliance with certain business category of a website, certain geographical properties of a website, certain number of links allowed in a certain page part, certain identity of a parent website, certain industry category of a website, certain page extension, certain semantic analysis of page content, and certain business category of a website page. Exemplary page extensions are .pdf, .html, .asp, .php.

It is provided for the first time a method for providing SEO rule data collection. The method comprises configuring SEO rule data collection for including one or more SEO operations, and transferring the rules to several websites. At least one rule includes SEO operation which is appropriate for several websites. The method may include the step of providing a management engine operative for interaction with an administrator regarding SEO rule data collection and for configuring the SEO rule data collection. The method may be carried by executing the instructions of an appropriate computer program, which may be stored in appropriate computer storage media.

It is provided for the first time a method for rule application. The method includes providing a rule implementing application of SEO operations of SEO rule data collection on website pages, receiving rule data collection, and applying the SEO operations of the SEO rule data collection on website pages to get optimized pages. The method may be carried by executing the instructions of an appropriate computer program, which may be stored in appropriate computer storage media.

It is provided for the first time a system for optimizing pages of websites for search engine presence and positioning. The system includes a management engine, a database for storing rule data collection, and a rule-implementing application. The management engine configures the SEO rule data collection, the SEO rule data collection is stored in the database and transferred to appropriate websites. The rule implementing application implements the SEO operations of the transferred rule data collection on appropriate website pages, thus getting optimized pages.

In some embodiments the system includes an administrator interface for interaction of an operator with the management engine. The interaction may be associated with SEO operations to be included in the SEO rule data collection and with application of certain SEO Rules data collection on certain website pages.

In some embodiments the system includes a page generator for receiving a page request and generate a responsive page.

It is provided for the first time a system for making SEO Rules data collection. The system includes a management engine and a database. The management engine configures SEO rule data collection to include one or more SEO operations. At least one SEO rule data collection includes SEO operations which are appropriate for several websites. The rule data collection database stores the SEO rule data collection and enables their transfer of to several websites.

It is provided according to some embodiments of the invention, a method of effecting search engine optimization (SEO) operations to multiple target web pages residing on multiple target web servers. The method includes reading from a memory a pre-defined rule data collection specifying content transformations of web pages, and modifying the target web pages. The effecting of the SEO operations is done by using computer processors executing computer-readable codes for automatically carrying out the method.

In some embodiments, the computer processors resides in a page-modification machine linked to the target web servers by a computer network, a LAN (local area network) computer network or the internet.

In some embodiments, the processor is linked via a computer network to a proxy. The proxy is configured for storing modified pages and for providing the stored modified pages upon a request from a page client for web pages associated with the stored modified pages.

In some embodiments, the content transformations includes web-page-transforming instruction like an instruction to inject links or meta-tags, to modify a web page title, or to inject a visible text or a hidden text.

In some embodiments, the method further includes selecting the target pages from a plurality of target pages, wherein only the selected target pages are subjected to the web page modification.

In some embodiments, the method further includes presenting to a user a configuration interface for providing specification data of a target web-page relating to search engine optimization, and the selecting is carried out according to the page specification data.

In some embodiments, the method is applied to a plurality of target web pages such that a first web page is subjected to a first pre-defined transformation specified by a first data sub-set of the pre-defined rule data collection, and a second web page is subjected to a second pre-defined transformation defined by a second data sub-set of the pre-defined Rule data collection. The second pre-defined transformation is different from the first pre-defined transformation, and the second data sub-set is different from the first data sub-set.

In some embodiments, the method further includes presenting to a user an administrator interface for interaction associated with a rule data collection, and interacting with the rule data collection via the administrator interface.

It is provided according to some embodiments of the invention, a method of facilitating search engine optimization of target web pages residing in target web servers by a rule implementing application residing as a local plug-in application in each of the target web-servers. The method includes providing a pre-defined rule data collection from rule storing servers, via a computer network, to the web-servers, and Reconfiguring the web-server by executing code of the rule implementing plug-in application to modify the target web pages in accordance with the provided rule data collection. The reconfiguring is done in response to the providing of the rule data collection to the web-servers.

In some embodiments, the method further includes installing the local rule-implementing plug-in application at the one or more web-servers.

In some embodiments, the rule data collections are provided to multiple web servers including a first target web server to which a first rule data collection is provided, and a second target web server to which a second rule data collection different from the first rule data collection is provided.

In some embodiments, for a given web-server the rule data collection providing is carried out in response with a rules-update request received from the rule-implementing plug-in application residing on the given web-server. Alternatively, the providing is carried out in response to a user-generated request, or in response to installing rule-implementing plug-in applications.

It is provided according to some embodiments of the invention, a method of facilitating SEO. The method includes associating a target web pages residing on a web server to a rule implementing application, and the rule implementing application applying pre-defined SEO rules to modify the associated target web pages and to generate modified web pages.

In some embodiments, the rule implementing application is a remote application residing on a remote rule implementing web server linked to the web server via a computer network. The associating of target web pages residing on a web server to the rule implementing application is done by sending a designation of the target web pages the remote rule implementing server via the computer network.

In some embodiments, the method further includes providing to the web server a designation of the modified web pages by the rule implementing web server. In response, the web server may be reconfigured to respond to requests for the designated target web pages by providing the modified web pages or a reference thereto.

In some embodiments, the method further includes detecting of a page modification of the target web pages, wherein the sending a designation of the modified web pages is carried out in a response to the detecting. The designation of the target pages may be done using a link or a uniform resource locator (URL) associated with the target pages.

In some embodiments, a local rule implementing application is residing in a certain web-server having the web-pages. The method further includes selecting an appropriate rule implementing application for modifying the one or more web-pages. In case the remote rule implementing application is selected a first routine is applied. The first routine includes sending to the a remote rule implementing server a designation of the target web pages, modifying the web-pages and responding to requests to the web-pages by designation of modified web-pages. In case the local rule implementing application is selected a second routine is applied. The second routine includes locally modifying the target web-pages by the local rule implementing application in accordance with rule data collections residing at the web server. The selecting of an appropriate rule implementing application may be done in accordance with workload on the remote rule implementing server and on the web-server.

It is provided according to some embodiments of the invention, a method of facilitating search engine optimization. The method includes reading from a memory pre-defined rule data collections for transforming web page, each of the rule data collections specifying one or more content transformations, intercepting a request for a web page sent via a network to a web server, requesting content of the web page from the web server, receiving the requested content, in accordance with the content transformations, modifying the received content of the web page, and sending the modified content of the web page to a source of the intercepted web page request.

In some embodiments, the method further includes caching the modified content of the web page in a cache. Later, on intercepting a request for the web page sent via the network to the web server, the modified content of the web page is retrieved from the cache. The method may be carried out on the web server or on a different server associated to the web server via a network. A decision on retrieving the modified content from the cache rather than modifying a requested web page is based on workloads on those servers.

It is provided according to some embodiments of the invention, a method of facilitating search engine optimization. The method includes providing a category map associating search engine optimization categories to rule data collections, presenting a plurality of search engine optimization categories to a user, associating by the user target web pages with one or more categories selected of the presented categories, and modifying the target web pages according to rule data collections associated by the category map with the selected categories.

The method may further include receiving by a search engine optimization plug-in application, executing at a host web server, a description of the selected categories, and effecting a look up in the category map to retrieve rule data collections corresponding to the selected categories.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a is a block diagram of a system for SEO with a detailed description of a website server according to some embodiments of the invention.

FIG. 1b is a block diagram of a system for SEO of multiple websites.

FIG. 1c is a block diagram of a system for SEO of a single website.

FIG. 1d is a block diagram of a system for SEO with a page modification machine.

FIG. 2 shows a table exemplifying editing actions and page selection criterion.

FIG. 3 is a block diagram showing a rule data collection, a source page, the corresponding viewed page, the resulted source optimized page and the respective viewed optimized page.

FIGS. 4a′ and 4a″ show a first example of an XML rule data collection.

FIG. 4b shows a page in HTML source presentation.

FIG. 4c shows a page as viewed in a browser.

FIG. 4d shows the first optimized page in HTML source presentation.

FIG. 4e shows the first optimized page as viewed in a browser.

FIGS. 5a′ and 5a″ show a second example of an XML rule data collection.

FIG. 5b shows the second optimized page in HTML source presentation.

FIG. 5c shows the second optimized page as viewed in a browser.

FIG. 6a is a flowchart of a method for optimizing website pages for search engine presence and positioning.

FIG. 6b is a flowchart of a method for optimizing website pages for search engine presence and positioning according to an embodiment with page selection criteria.

FIG. 6c is a flowchart of a method for optimizing website pages for search engine presence and positioning according to an embodiment with page generation before optimization.

FIG. 7 is a flowchart of a rule making method.

FIG. 8 is a flowchart of a rule application method.

FIG. 9a is a flow chart of a method for effecting SEO operations.

FIG. 9b is a flow chart of a method for facilitating SEO operations by a rule implementing plug-in application.

FIG. 9c is a flow chart of a method for facilitating SEO operations by a remote rule implementing server.

FIG. 9d is a flow chart of a method for facilitating SEO operations using a cache.

FIG. 9e is a flow chart of a method for facilitating SEO operations using a category map.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described SEO is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “such as”, “include” and “have”, and conjugates thereof, are used to indicate that the object or objects of the verb are not necessarily a complete listing of members, components, elements or parts of the subject or subjects of the verb.

### DEFINITIONS

Part of the definitions in this section, as well as terms and arguments in the related art section, are taken from US application 2008077556 to Muriente.

A website page may have two possible phases, a source phase in which the markup language version is shown and a browser viewed phase in which the page appears in a much more readable form. Source Website pages are written using languages such as HTML and PHP. A web browser, such as Microsoft Explorer and Firefox, gets the source file and convert it into a readable document, seen by the end user over a screen, for example.

HTML stands for Hyper Text Markup Language. HTML provides a means to describe the structure of text-based information in a document by denoting certain text as links, headings, paragraphs, lists, and so on. It also supplements that text with embedded images, interactive forms, and other objects. HTML is written in the form of tags surrounded by angle brackets. HTML can also describe, to some degree, the appearance and semantics of a document, and may include embedded scripting language code (such as JavaScript) which may affect the behavior of web browsers and other HTML processors.

Page generator, or Internet publishing platforms, are software applications hosted on an Internet web server that are designed to enable the publication of Web documents and provide them to end users who request them on the World Wide Web. The website server itself functions as a page generator when it submits a static page in response to reception of the page Uniform Resource Locator (URL).

A more complex page generating task is to provide a dynamic page in response to a page request which includes a list of parameters. In response, the page generator collects data items from various parts of the web site, such as databases, and integrate them into a source page specifically for providing a response for the page request. For example, in a commercial website the customer fills an interactive form which specifies a desired item and submits the form, which serves as a page request. In response, the page generator identifies the desired item, takes its figure from figure database, its price from pricelist database and the number of available items from a stock database. Finally, the page generator assembles the figure, price and number of available items into a single page which is submitted to the customer browser.

A dynamic generated page may be archived, enabling fast retrieval by other user asking the same page, allowing crawling and indexing by a search engine, and permitting a later post-processing.

Crawling is the process by which a search engine discovers a website page or document on the Internet and stores its address and/or retrieves its content.

Indexing is the process by which a search engine analyzes or parses a crawled website page or document, derives appropriate data items and keywords using proprietary techniques, and stores the data items in the search engine index.

Once a page appears in the index in association to certain keyword, it may be ranked. Ranking is the procedure by which a search engine determines the numeric position of each of the website pages and documents in its index, which are associated to the keyword, and thus should be returned in response to a user-generated query which includes that keyword.

XML stands for Extensible Markup Language, a general-purpose specification for creating custom markup languages.

Note that the term rule file used in the priority US provisional application is replaced along this disclosure with the term rule data collection or SEO rule data collection. Similarly, the term rule applicator of the priority application is replaced hereafter by the term rule implementing application. The term rule implementing plug-in application is used for the application is placed on the website server (website server side).

### General Description of System Configurations

The present invention is a method, apparatus and computer-medium for search engine optimization (SEO). First, a general description is given with emphasis on the variety of system configurations for implementing the disclosure. Then, several system and method embodiments are fully described.

For the present disclosure, an “SEO rule data collection” or a “rule data collection” is a set of one or more instructions or steps to be carried out to modify content of a web page in order to attempt to improve search engine placement of the web page. Exemplary SEO rule data collections include but are not limited to: (i) “content injection rules” or rules to inject a specific type of web page content. Web page content types include but are not limited to links, hidden text and meta-tags. (ii) “content deletion rules” or rules to delete a web page content item of a specific type. For example, to delete a specific link or a link that includes specific text or a specific meta-tag. and (iii) “content modification rules” or rules to modify a content item on the web page. For example, a directive to modify a web page types or a directive to modify a link prefix or link suffix for links on the page.

It is understood that not every conceivable “SEO rule data collection” may be categorized into one of the three aforementioned categories. For example, a rule may include a directive to replace a certain page with another page, or to perform certain action locally or remotely on a server.

A pre-defined SEO rule can be described at least in part by using pre-defined SEO rule data collection. According to a first example relating to “content injection rules” the pre-defined SEO rules data collection may include one or more of a specific link or meta-tag or hidden text to be inserted into a page. According to a second example relating to “content injection rules”, certain text is to be added to the end of each HTML title, and the pre-defined SEO rules data collection may include the actual text which is to be added to the end of each HTML title. According to a third example relating to “content deletion rules” the pre-defined SEO rules data collection may include specific content to be deleted from the page—for example, if the content deletion rule is a rule to delete all references to specific text, the pre-defined SEO rules data collection for this content deletion rule may be the actual text to be deleted. According to a fourth example relating to “content modification rules”, if all appearances to a certain link (i.e. “Link A”) are to be replaced with a new link (i.e. “Link B”), then the pre-defined rules data collection be the text of “Link A” and “Link B.”

Optionally, the SEO rules may be conditional—i.e. only applied if one or more conditions are met. For example, a specific SEO rule may be defined so that the specific SEO rule is only to be applied to web pages whose uniform resource locator (URL) includes a certain string, or only to web pages which include certain content, or even only to be applied at a specific time of day or week. For example, only web pages that include the word “bank” may be modified.

In this case, the conditions for which an SEO rule is to be applied may also be pre-defined, and the pre-defined SEO rules data collection may include: (i) the actual URL pre-fix; (ii) the actual content which must be present for a specific conditional SEO rule to be applied; and/or (iii) a description of the time of the day or time of the week when a given SEO rule is to be applied.

In yet another example, there may be a list of potential SEO rules that can be applied and each SEO rule is associated with a specific identifier—for example, “RULE 1” may represent an SEO rule to insert a link, “RULE 2” may represent an SEO rule to delete a metatag including specific text, and “RULE 3” may represent an SEO rule to replace an HTML title with new title text. In this case, the “pre-defined SEO rule data collection” may include the SEO rule identifier.

Thus, a rule to insert a link to the URL www.jpmorgan.com may be stored as the ordered pair {“RULE 1,” www.jpmorgan.com}. The SEO rules data collection may be electronically stored in any manner that is apparent to the skilled artisan after reading the present disclosure. In one example, the rules data collection is stored as a file in a “rule data collection”, for example, in an “XML file” or in any other type of manner. In yet another example, the rule data collection is stored in a relational or object-oriented database.

It is noted that the reading of the SEO rule data collection and the modifying of the target web pages may be carried out by one or more computer processors deployed in any location within a computer and/or computer network. In one example, the computer microprocessor which effects the modification of the target web pages is part of the same machine or web server 45 that hosts the target web pages. In another example, the computer microprocessor which effects the modification of the target web pages is in a location that is separate from the host web server 45, in page modification machine 107, separated from the host web server via a local or wide area computer network.

Exemplary volatile memory includes but is not limited to RAM and register memory. Exemplary non-volatile memory includes but is not limited to magnetic medium (i.e. CD or DVD memory) and flash memory. The memory may reside in any location.

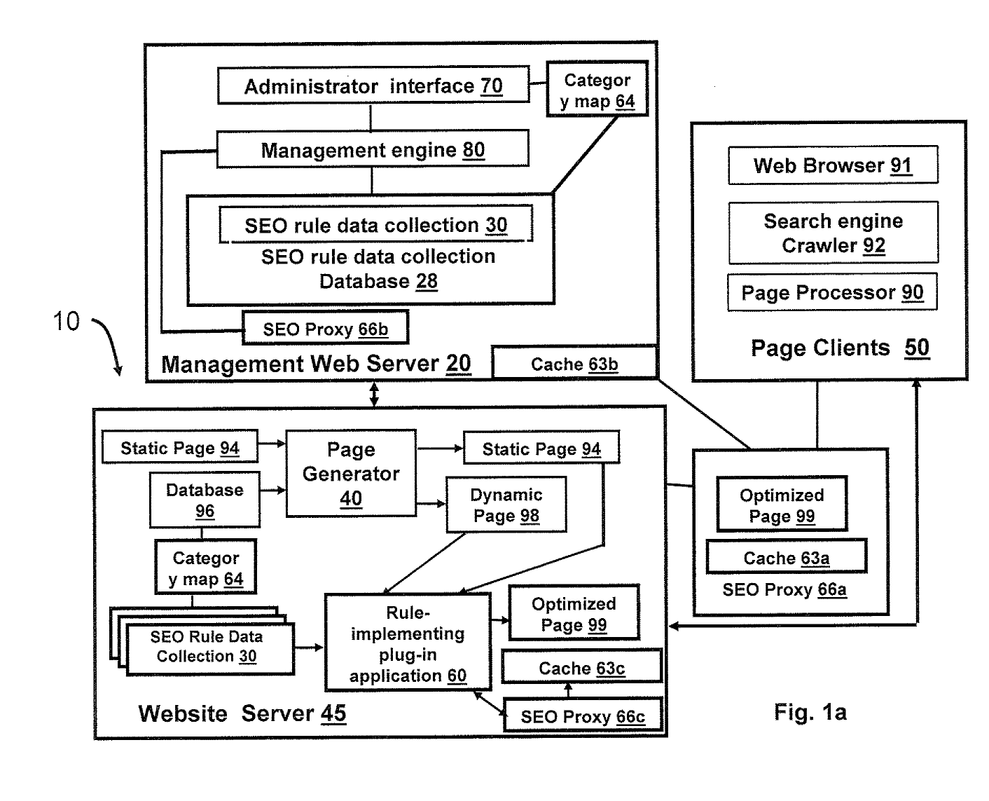

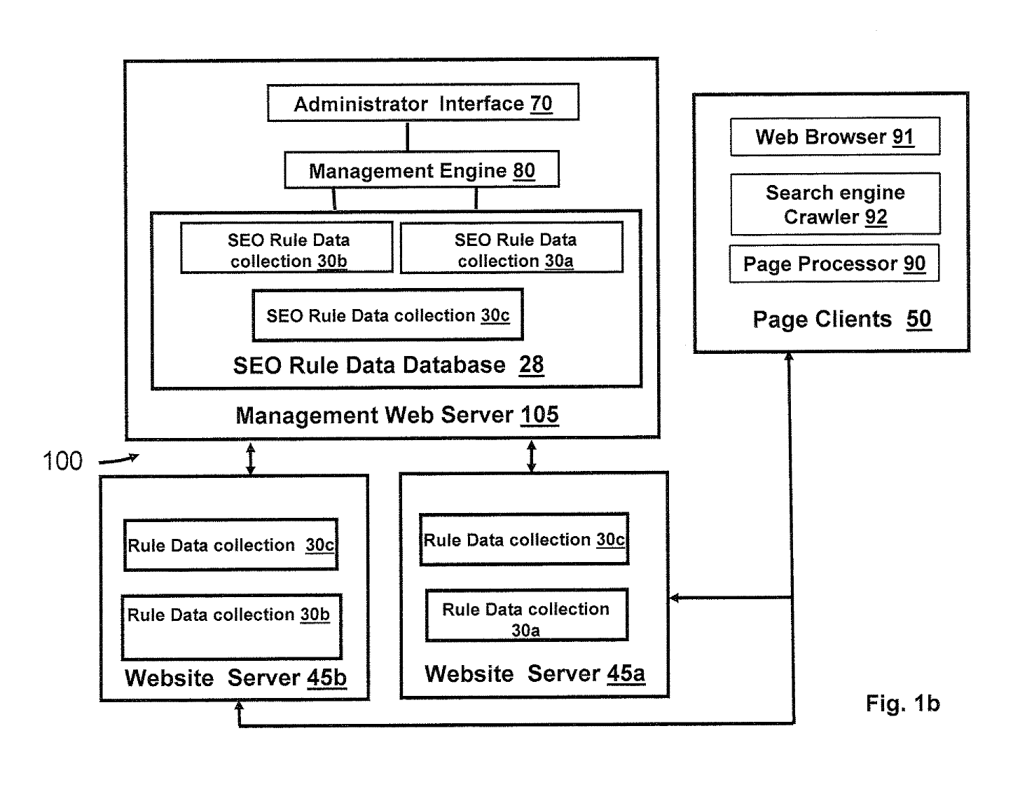

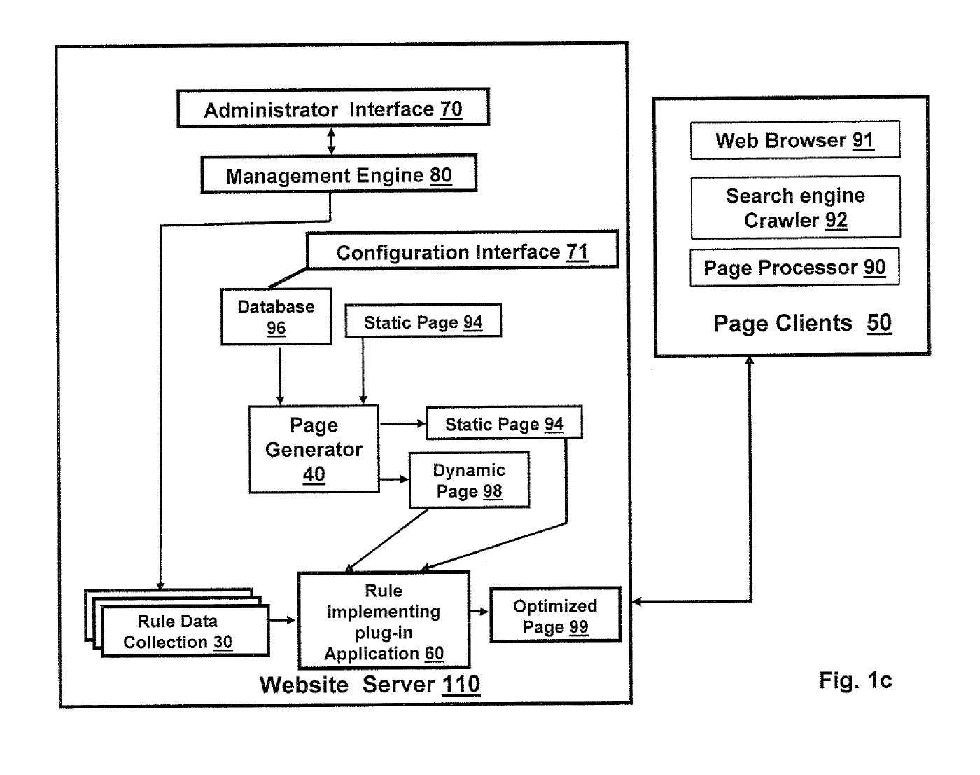

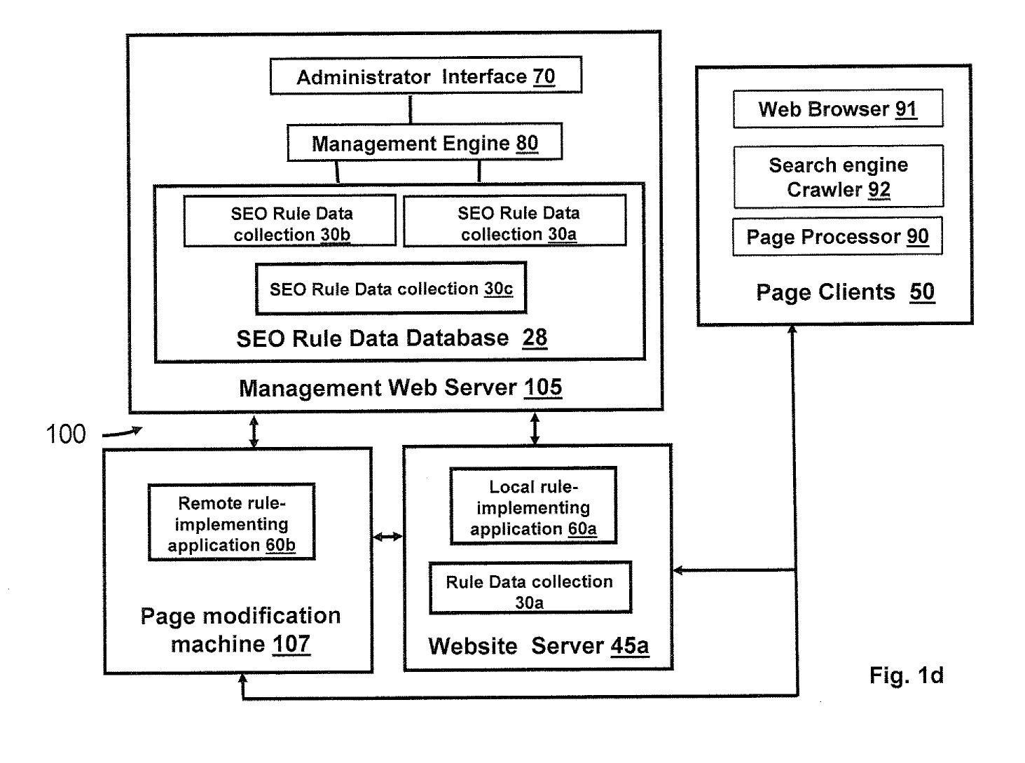

In the example of FIG. 1a, the rule-implementing application resides on web server 45 and thus is referred to as a SEO “rule-implementing plug-in application, or “rule implementing application”.

For the present disclosure, any executable computer code which resides in computer memory on the web server side is referred to as an “SEO rule implementing plug-in application.” One non-limiting example of a plug-in application is a “SEO rule-implementing application” plug-in which applies one or more pre-defined SEO rules by reading SEO rule data and modifying one or more target web pages 45.

For the present disclosure, a “SEO rule-implementing application” is computer executable code residing on computer memory (i.e. volatile or non-volatile) which when executed by a computer processor effects a routine. In the example of FIG. 1a, the rule-implementing application is a “plug-in” application which resides on the “web server side” 45. In the example of FIG. 1d, the rule-implementing application is a “remote” application which resides remotely—i.e. at another location 107 on the Internet which communicates with the host web server 45 via the internet.

The disclosed method is changing web pages transparently without needing to be aware of any particular layout, graphics, code or characteristics of the page, where the rule-implementing application intercepts the original page generated by the web server and apply the changes to the output page using source of SEO rules data collection stored locally or on a Remote rule storage server.

Reference is now made to FIG. 1a, in which SEO rules data collection 30 is copied or transferred via the Internet from the remote SEO rule storage serve(s) 20, where they reside in a database 28. Thus, in one non-limiting use case, the “owner” of the web server 45 wants the web pages SEO optimized and “subscribes to a remote service” 20 whereby some or all of the web pages on the web server 45 are automatically SEO-optimized. In this non-limiting example, an SEO rule-implementing plug-in application is installed on the web server 45 configured to read SEO rule data collection 30 on the “web server side.” In this non-limiting example, from time to time, the SEO rules data collection 30 is copied or transferred from a remote SEO rule storage server 20. Thus, SEO operations may be carried out accordance with “updated rules data collection.” In one example, it is determined by the organization controlling remote rule storage server 20 that a certain meta-tag, which over the last 6 months was useful for obtaining a high ranking on the Google® search engine, is now handled differently by Google®, rather than improving search engine ranking it now causes the web page to have a lower ranking. In this non-limiting example, new SEO rules data collection 30 indicating that the certain meta-tag should not be injected, is copied or transferred from the SEO rule storage server 20 via the internet to the host web server 45. In summary, the SEO rule implementing application 60 changes the way it modifies web pages for SEO in accordance with received new data.

FIG. 1b relates to the use case where there are “multiple subscribers”—say N subscribing website 45 where N is a positive integer. In this non-limiting example, each subscriber may receive a different set of customized SEO rule data collection relating to subscription parameters. Thus, in one particular case, content on web server 45a is to be optimized for “banking”, whereas content on web server 45b is to be optimized for “politics”, and content on another web server is to be optimized for “sports.” In this non-limiting example, from time to time, the remote rule storage server 20 will update, simultaneously or not simultaneously the SEO rule data collection 20 by copying or transferring the appropriate “rules data collection” for a target web server to the web server, collection 30a to server 45a and collection 30b to server 45b. In the example of FIG. 1b, there is no need to update the SEO rule-implementing plug-in application 60 itself, as it is sufficient to just to copy or transfer the updated data via the Internet using rule data collections 30a and 30b.

FIG. 1d relates to an architecture where the method is carried out using a remote rule-implementing application 60 which resides “remotely” on remote rule implementing server or page modification machine 107. A description of a “target web page” 94 or 98 to be optimized is sent (for example, by an executing ‘manager’ plug-in application 60) via “the cloud” from the host web server to the remote server 107 on the remote server, and the content is SEO optimized. The optimized content or a description of where the optimized content is stored is sent back to host web server 45.

It is noted that the “remote” architecture of FIG. 1d and the “local” architecture of FIG. 1a are not mutually exclusive by any means. In one embodiment, some of the SEO optimization may be carried out by the executing ‘local’ SEO rule-implementing plug-in application 60 and some of the SEO optimization may be carried out the executing ‘remote’ SEO rule-implementing application 60b.

In one non-limiting examination, a “local work load” may be detected or estimated—in the event that the ‘local work load’ is relatively high, then it may be advantageous to carry out more SEO remotely. Conversely, in the event that the ‘local work load’ is relatively low, then it may be advantageous to carry out more SEO locally.

FIG. 1a also depicts a “proxy architecture” for SEO. A page client 50 sends a request to the host web server 45 for web content, including one or more web pages. This request is intercepted by an SEO proxy 66a, 66b or 66e. In the event the requested page was already modified for SEO, then the SEO-modified ‘optimized’ content (for example, generated according to pre-defined SEO rules) is retrieved from an SEO-modified content cache 63 and is sent to page client 50.

Alternatively, the request may be passed on and “raw” content (i.e. not subjected to the desired. SEO operation may be retrieved, be optimized and optionally stored in the content cache 63. For this situation, carrying out the SEO optimization operation is done in response to the sending of the content request from page client 50.

Proxy 66a may be implemented in any manner, for example, as an executable code module stored in computer memory executed by a computer processor. Proxy 66a (and cache 63a, 63b and 63c) may reside in any location on a computer network, for example, on host web server 45 and/or at a remote location 66a.

One advantage of the architecture described in FIG. 1a is that there is no need to change the “raw content”. This may make it easier to maintain the raw content without any need to be aware of SEO considerations.

Another benefit of this architecture is that there is no need for SEO proxy 66a to change the original visual layout of the page or any embedded scripts of code of the web page. Thus, the SEO modification of the web page can be “transparent” to the user who views the web page in his/her web browser.

FIG. 1a also show how a user can configure how s/he wants to optimize target web pages 94 or 98. In the example of FIG. 1a, there is a category map 64 between SEO categories and SEO rules data collections. For example, the category “Banks” may require inserting links to citibank.com, chase.com and boa.com. The category “sports” may require inserting links to mlb.com, nfl.com and nba.com. The category “politics” may require inserting links to www.obama.com and www.mccain.com.

In this example, there is a “map” between individual categories and the set of rules (or pre-defined SEO rules data collection) associated with the category. A representation of category map 64 is stored on electronic devices, like management web server 20.

The user can then decide how to optimize various web pages. For example, the user may decide that all web pages in directory “sp” are to optimized according to the “sports rules”; all web pages in directory “pl” are to optimized according to the “politics rules”; all web pages in directory “bk” are to optimized according to the “banking rules.”

In this case, a category graphical user interface (GUI) or “configuration interface” 71 whereby the user can specify for a given target web page which category or “categories” of SEO rules can be applied to the target web page 94 or 98. This GUI may be presented via a display screen; the user's selections may be received via a user input device such as a mouse or keyboard.

A rules data updater or a management engine 80 updates the rule data collection 30 in accordance with (i) the user's selections on the category GUI and (ii) SEO category map 64.

Thus, in one example, in the SEO category map 64, category A is associated with rules XYZ and category B is associated with rules WYZ.

In this example, on July 1, web page “J” is associated with “category A” only. Thus, target web page “J” is SEO optimized according to rules XYZ. In this example, on July 15, the user using GUI 71 to modify the configuration such that web page “J” is no longer associated with “category A” but is now associated with category “B” instead. In this case, rules data updater 80 detects this “change of state” induced by user usage of GUI 70, and updates SEO rules data collection 30 (i.e. for web page “J”) so that rule “x” (i.e. as represented by the associated rules data collection) is no longer applied while rule “w” is applied instead, while rule “yz” will continue to be applied.

In yet another example, the user may select which pages are to be targeted for SEO page modification—for example, via a configuration interface 71 (e.g. GUI). Thus, in some embodiments, the user may provide “SEO target page specification data” which is received via the configuration interface—for example, a URL prefix of pages to be SEO modified, or keywords that must be on a page in order for the page to be SEO modified. Alternatively or additionally, this selection may be automatic or carried out according to any criteria.

In some embodiments, a first set of SEO rules may be applied to a first set of target pages (for example, SEO rules associated with SEO for the banking industry—for example, inserting bank-related links or metatags), and a second set of SEO rules may be applied to a second set of target pages (for example, SEO rules associated with SEO for sports—for example, inserting sport-related metatags).

In one example, the SEO rules data collection may be provided explicitly by a user, for example, as an XML file or via an administrator interface 70.

Several method and system embodiments for SEO using rule data are described herein. The rule data collection are constructed by a management engine which may be guided by a SEO consultant. A rule implementing application applies the Rule data collection on appropriate website pages, thus creating optimized website pages. The invention provides for automatic implementation of certain SEO operations on many website pages, saving a lot of page editing and programming work load.

### SEO System Embodiments

A system 10 for optimizing pages of a website for search engine presence and positioning is described in FIG. 1a. The system 10 is divided between management web server 20 and website server 45, which may be connected via the internet. System 10 includes a management engine 80, a repository 28 for storing rule data collection 30, a database for example, and a rule-implementing plug-in application 60. The management engine 80 configures the rule data collection 30 for including SEO operations, the rule data collections 30 are stored in rule data collection database 28 and may be transferred to website server 45. The rule-implementing plug-in application 60 applies the SEO operations of the transferred Rule data collection 30 on appropriate website pages 94 and 98, thus getting optimized pages 99.

The rule data collection database 28, which is an example of a file repository for the rule data collection 30, may be a flat database or a hierarchical database or any other form of data storage structure.

System 10 includes an administrator interface 70 for interaction of an operator or an administrator with the management engine. The interaction may be associated with SEO operations to be included in the rule data collection and with application of certain rule data collection 30 on certain websites or certain website pages. For example, an administrator, or SEO consultant, may deal with five website in the category of real estate. The administrator may direct the management engine to construct a rule data appropriate for the real estate category and send it at once to all five websites, thus saving a lot of duplicate workload.

System 10 may also include a page generator 40. Page client 50 sends a page request to the web server 45. The page generator 40 generates a response generated page. The rule-implementing plug-in application 60 applies rule data collection 30 on the generated page, gets an optimized page 99 and submits it to page client 50.

In general, the page client 50 requesting a page is a page processor 90. A common page client 50 is a web browser 91 in which a user indicated a URL associated with a page, pressed a hyperlink leading to a page, or submitted a form having several data items. Another page client 50 is a search engine crawler which moves along a “tree” of pages and index their contents.

In response a page request, the page generator 40 may copy all or part of a static page 94 from a database associated with a website having the requested page, or integrate a dynamic page 98 from data items available in a variety of databases. A database may be located in the website server 45 like database 96. A database may also be located outside the website server 45.

An exemplary SEO operation is page editing action of adding an element to a part of a generated page. The element may be a link, a piece of text, a keyword, a piece of meta data, and a layout, wherein a layout is an overall look of a page. The page part may be a header, a footer, a body of a page, and its meta data part. An example of a page editing action and an associated page selection criterion appears below.

An optimized page 99 which have been sent to a page client upon its request, either a static or a dynamic page, may be stored in the web server as an optimized page 99 for later use. Cache 63c may be used for storing optimized pages 99. For example, imagine website www.AmFePo.com, an acronym for American Federal Politics, having a database which includes pictures and biographic details of past and present senators and congressmen, whereas the website is taken care by system 10. In Aug. 24, 2008 the democratic presidential candidate senator Barack Obama declares that he have elected senator Joseph R. Biden Jr. as vice-president candidate. Immediately, Mr. Smith of California submits a page request to www.AmFePo.com to have Biden's picture and certain biographic details. Page generator 40 collects the requested data items, and integrates a responsive generated page. Rule-implementing plug-in application 60 optimizes the page, adding “vice-president” and “Barack Obama” to the meta data part, and the optimized page is submitted to Mr. Smith and simultaneously stored as an optimized page in the website archive, which is accessible to the public. In Aug. 25, 2008, Google crawler finds that page and index it, ranking it highly for the “vice-president” and “Barack Obama” keywords. Consequently, the next week the page appears in the first position for the numerous page clients searching “vice-president AND Barack Obama”. Thus, the optimized page is being visited again and again, and may be used as a landing page to attract visitors to other parts of the website.

Referring now to FIG. 1b, the figure emphasizes the use of a single Rule data collection for several website servers. Rule data collection database 28 stores rule data collection 30a, 30b and 30c. An administrator instructs management engine 80, through administrator interface 70, to destine rule data collection 30a and 30c to website server 45a, and Rule data collection 30b and 30c to website server 45b. Once in a while, each website server inspects in database 28 whether it includes new rule data collection destined to it, and initiates reception of these new rule data collection. Thus, rule data collection 30c is transferred to multiple website servers.

FIG. 1c shows a system for SEO of a single website which is hosted by a website server 110. The management engine 80 configures rule data collection 30 for immediate use by the rule-implementing plug-in application 60.

In some embodiments, the rule data collection 30 may be applied only on part of the website pages. To that aim page selection criteria are being defined, by the administrator for example. The page selection criteria are associated with certain Rule data collection, and that Rule data collection is applied only on pages which are in compliance with the respective page selection criteria.

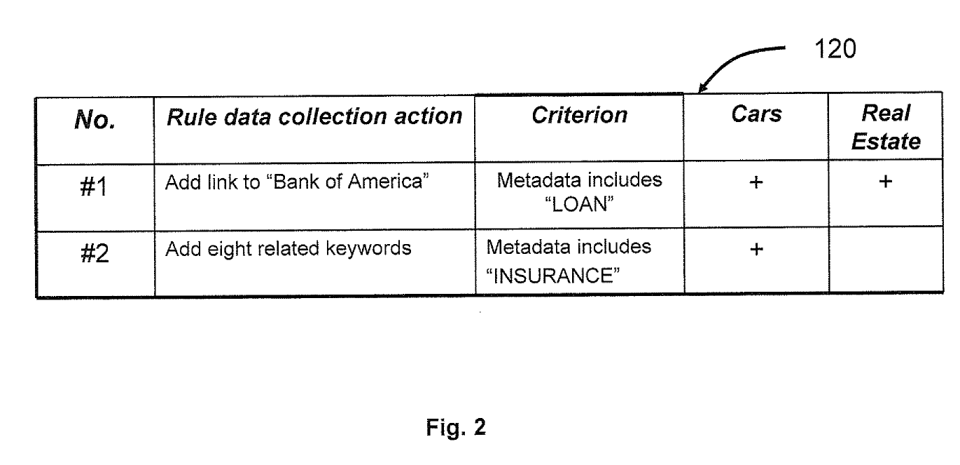

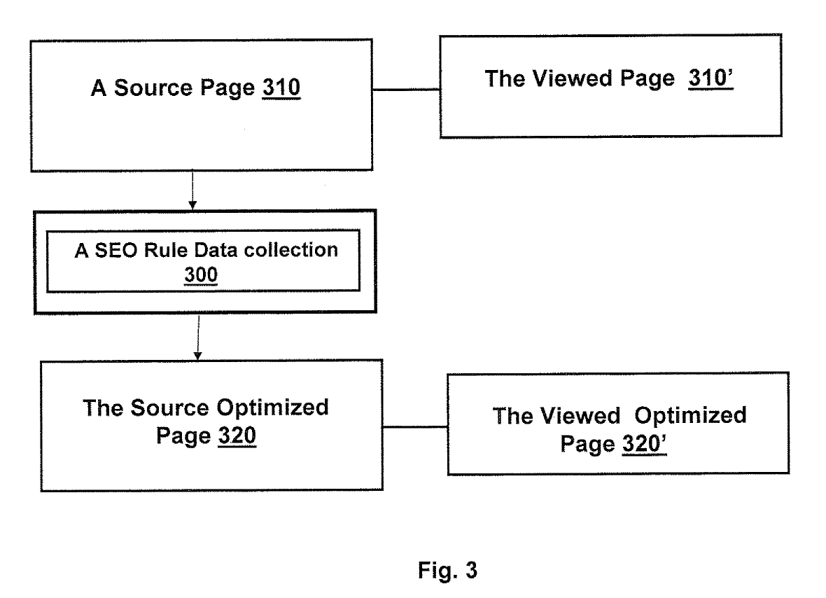

The association of the rule data collection action to page selection criteria is illustrated in table 120 of FIG. 2 for a bulletin board website with sub-sections for cars and real estate. The action of Rule data collection #1 is to add a link to “Bank of America”, and the page selection criterion associated with the Rule data collection is that the metadata includes the keyword “LOAN”. Thus, the Rule data collection applies for both sub-sections. In contrast, Rule data collection # 2 includes the action “add eight insurance related keywords” and the page selection criterion is that the metadata includes the word “INSURANCE”. That word appears only on pages of the CARS sub-section, and therefore the Rule data collection #2 is applied only to pages in sub-section “CARS” and not to pages in sub-section “REAL ESTATE”.

### Examples of Page Edition Actions

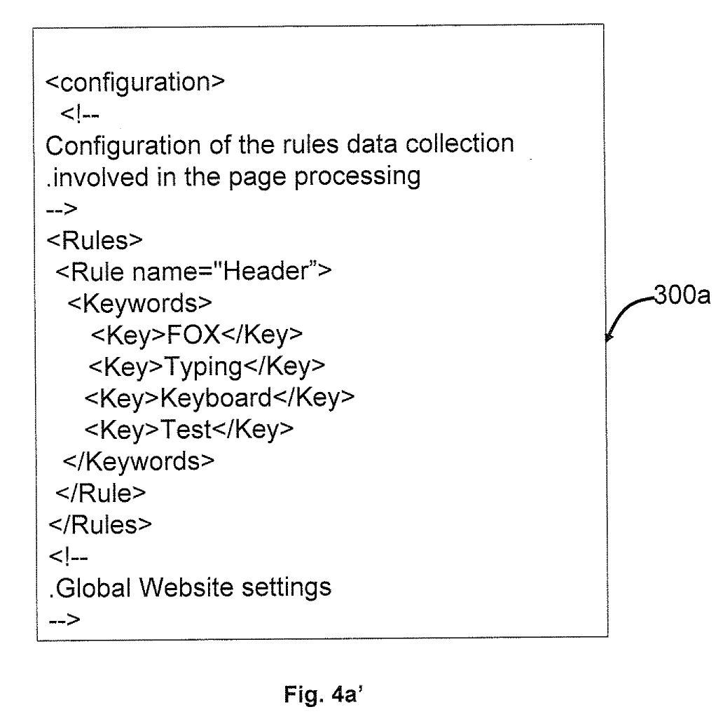

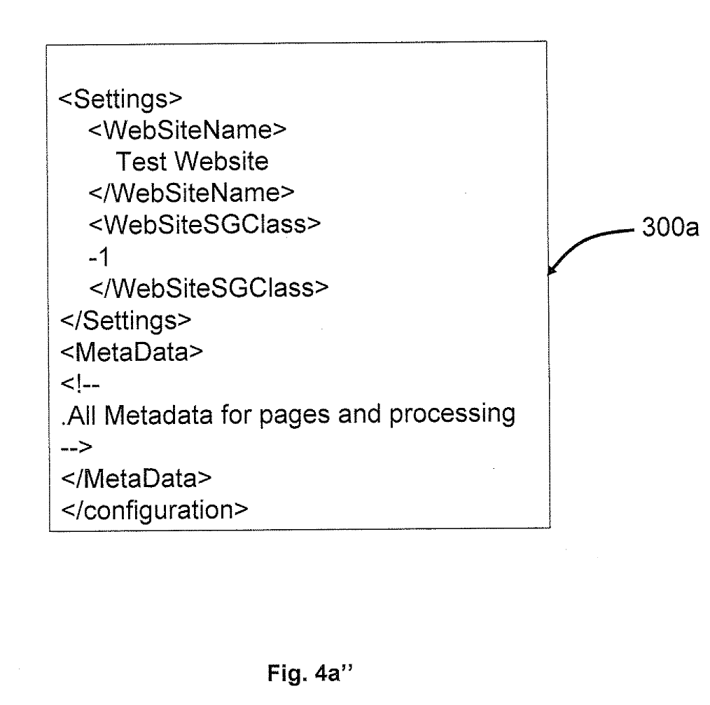

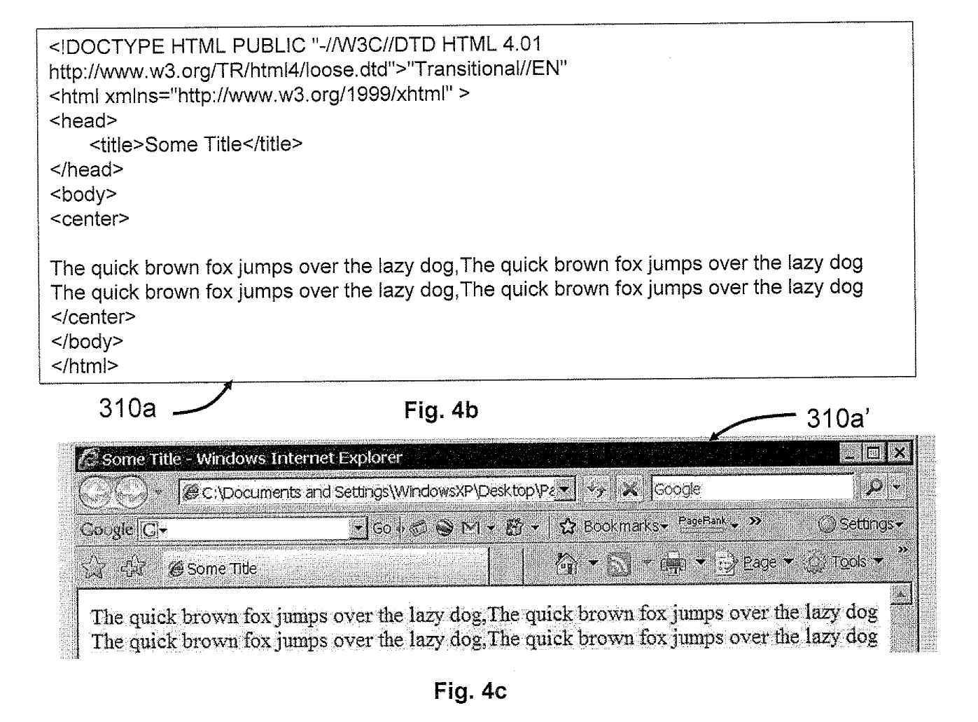

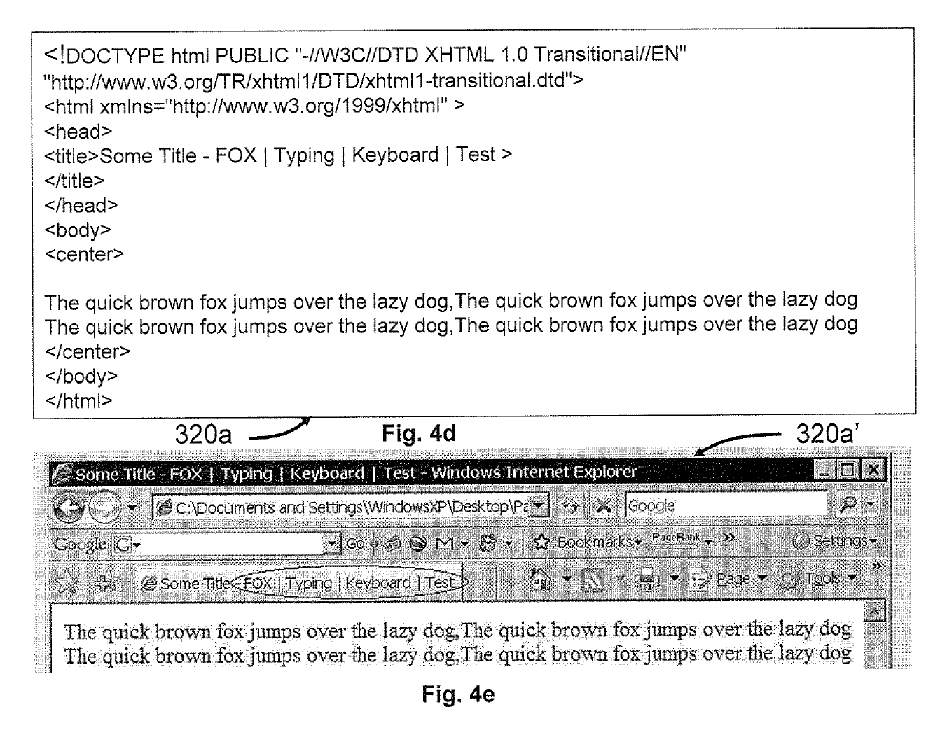

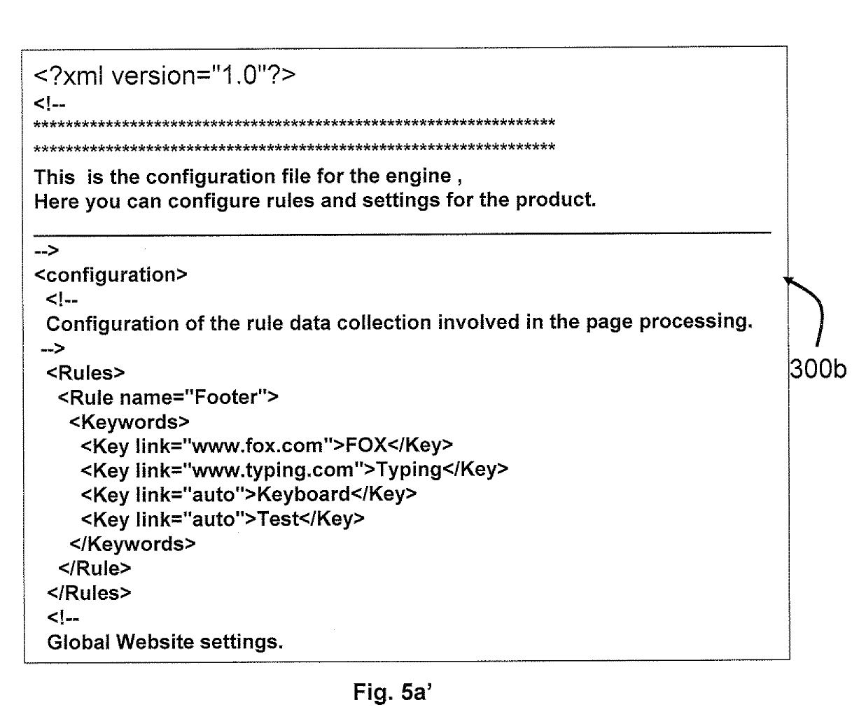

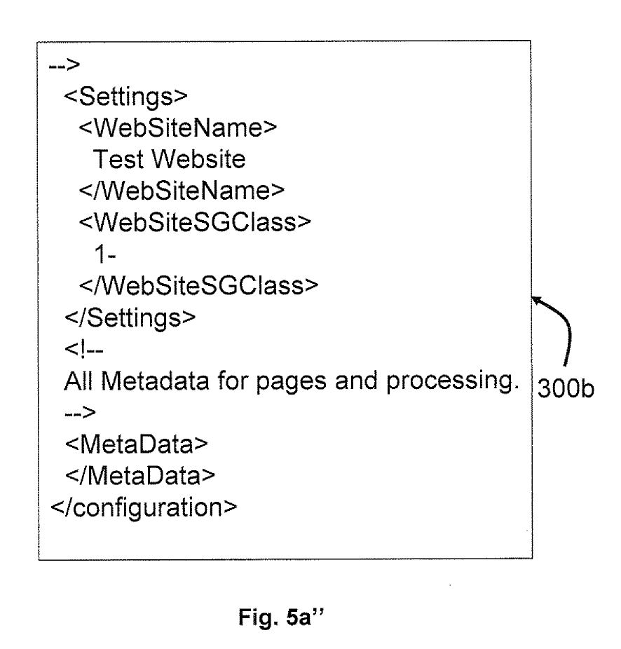

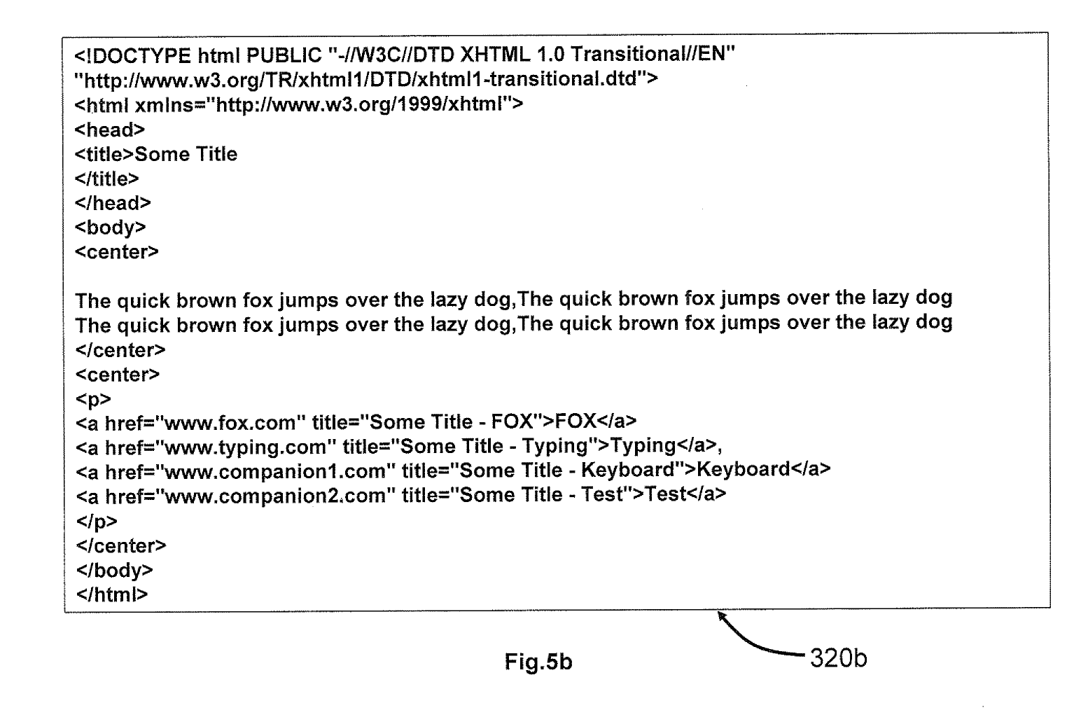

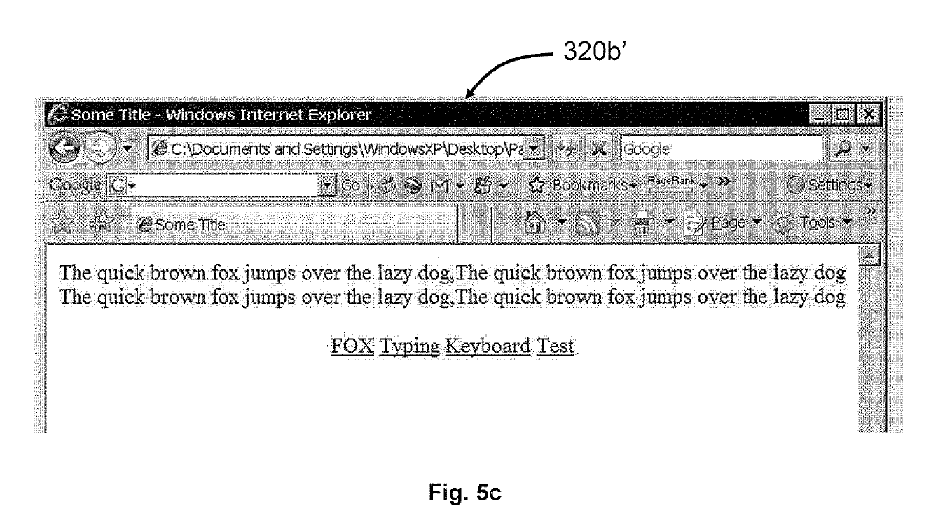

Examples of page edition actions are presented in FIG. 4-5. FIG. 4 shows a block diagram of five relevant rule data collection. An rule data collection 300 includes page edition actions which may be applied on a page. The source file 310 is viewed as viewed page 310′. The application of the page editing actions of rule data 300 on the source file 310 results in a source optimized page 320, and viewed optimized page 320′.

FIGS. 4a′ and 4a″ present a first XML rule data 300a for adding keywords “FOX”, “Typing”, “Keyboard” and “Test” to a page title. FIG. 4b shows a source file 310 and FIG. 4c shows the viewed page 310′. Once the XML rule data file 300a has been applied on source file 310a, one gets optimized file, shown in FIG. 4d in its source phase 320a and in FIG. 4e in its viewed phase 320a′. Note that the desired keywords appear in the title of 320a′.

A second example is shown in FIG. 5. FIG. 5a′ and 5a″ present a second XML rule data file 300b which includes the page editing action of adding four hyper links to the body of the page. The same source page 310a is used for the present example. FIG. 5b shows the source optimized page 320b and FIG. 5c shows the viewed optimized page 320b′, having the four desired hyperlinks as desired.

### Method Embodiments for Search Engine Optimization

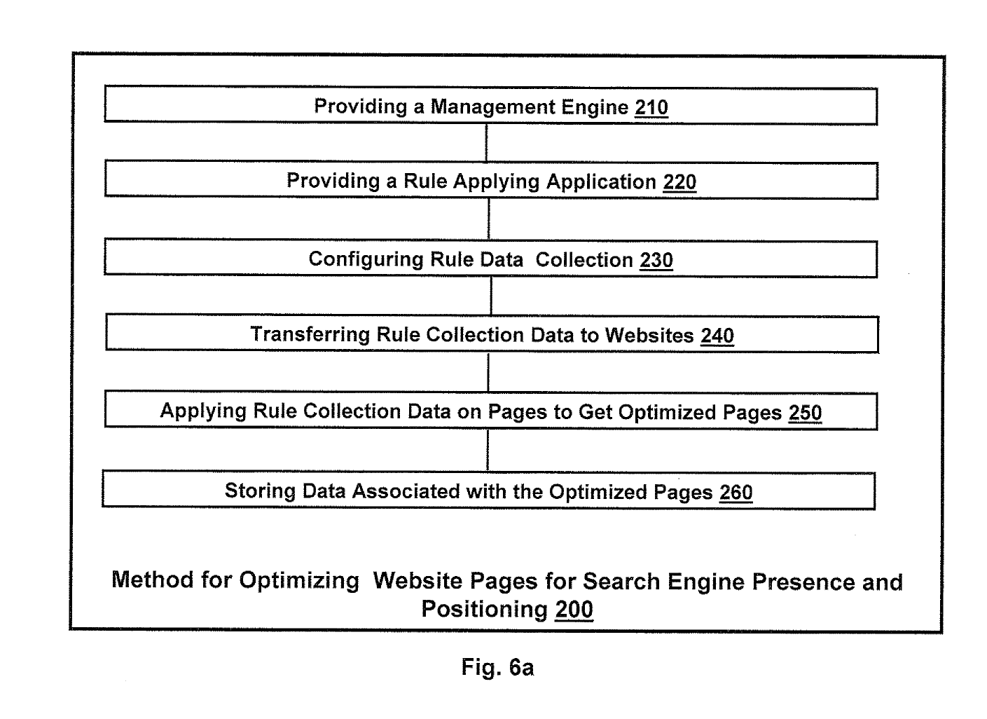

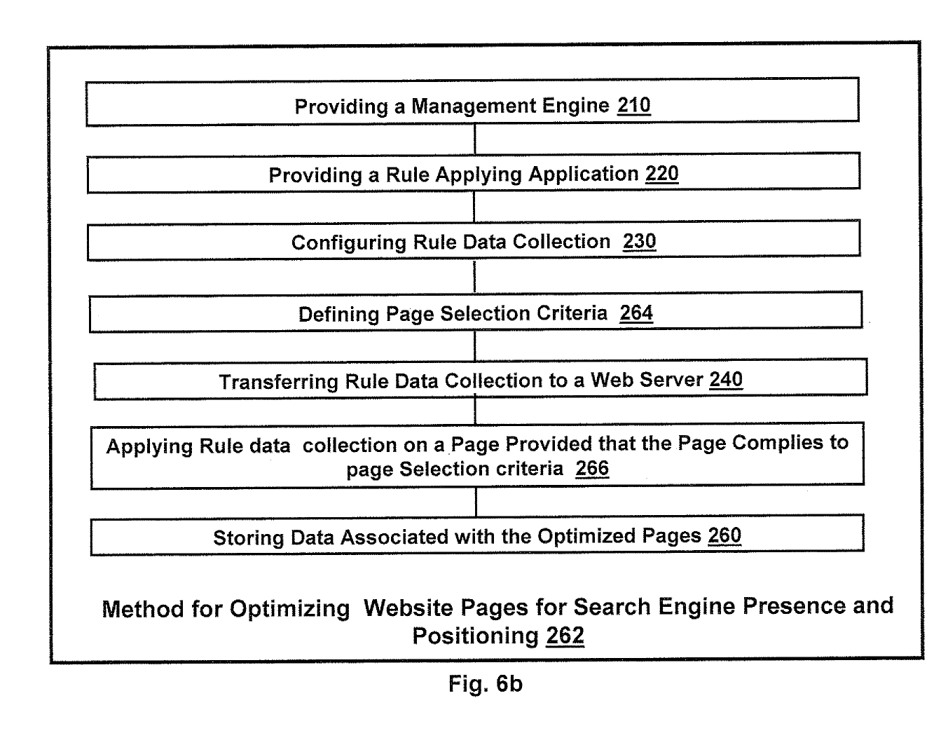

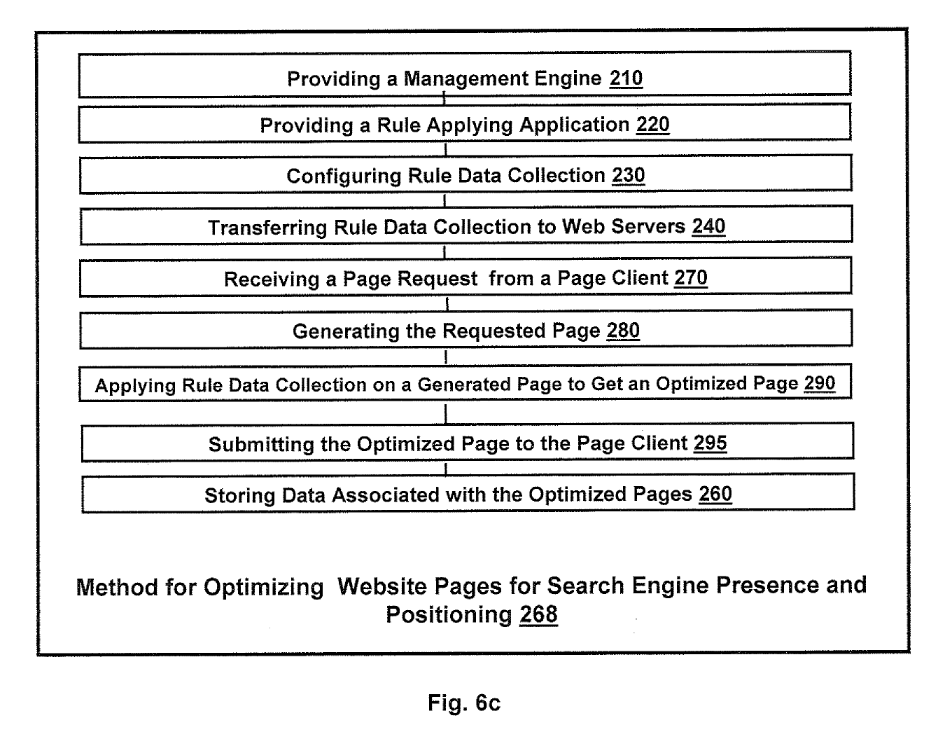

A method 200 for optimizing website pages for search engine presence and positioning is presented in FIG. 6a. Method 200 includes the following steps:
(a) Providing 210 a management engine 80. In one example, the management engine 80 is installed in a management web server 20.
(b) Providing 220 a rule-implementing application 60. In one example, the rule implementing application is installed in website servers 45a and 45b.
(c) Configuring 230 rule data collection 30.
(d) Transferring 240 rule data collection 30 to multiple websites 45a and 45b.
(e) Applying 250 rule data collection 30 on website pages 94 and 98, thereby getting optimized pages 99.
(f) Storing 260 data associated with the optimized pages 99.

Note that here above and hereafter the word “transferring” describes the action of moving rule data collection from their creation place (management side) to their destination place (website side) for both the case that the action is initiated and/or managed from the management side and the case that the action is initiated and/or managed from the website side.

In some embodiments the stored 260 data is the optimized pages 99 themselves. In other embodiments, the stored 260 data is creation time of the optimized pages and/or information on the changes carried out by the rule-implementing application in applying the rule data collection 30.

A method 262 for optimizing website pages for search engine presence and positioning is presented in FIG. 6b. Method 262 includes the following steps:
(a) Providing 210 a management engine 80.
(b) Providing 220 a rule-implementing application 60.
(c) Configuring 230 rule data collection 30.
(d) Defining 264 page selection criteria.
(e) Transferring 240 rule data collection 30 to a website server 45.
(f) Applying 266 rule data collection 30 on a website page 94 or 98, provided that the page complies to the page selection criteria.
(g) Storing 260 data associated with the optimized pages 99.

Method 262 may be utilized in the single website server example of FIG. 1c. In that case, step (e) is not carried out as the Rule data collection 30 are already in the website server 110 where the rule-implementing application 60 applies them on the website pages.

A method 268 for optimizing dynamic pages is illustrated in the flowchart of FIG. 6c. It further includes the steps of receiving 270 a page request from a page client, generating 280 the requested page, applying 290 Rule data collection on the optimized page 99 and submitting 295 the optimized page 99 to the page client 50.

### A Method Embodiment for Configuring Rule Data Collection

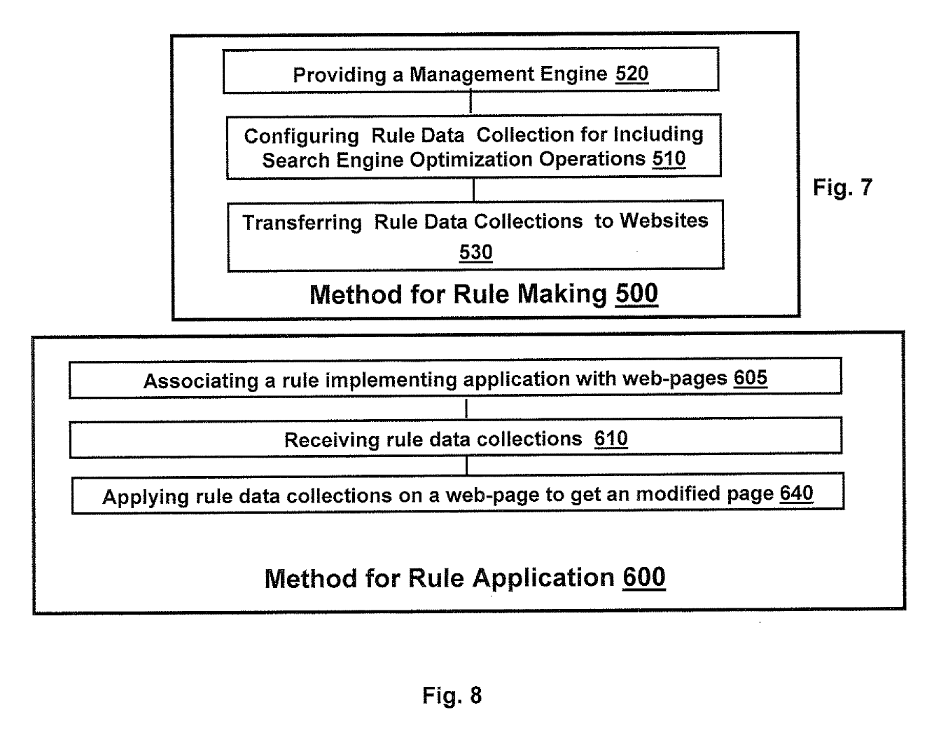

A method 500 for configuring rule data collection is illustrated in the flowchart of FIG. 7. The rule data collection are prepared for applying SEO operations on website pages, thus optimizing the pages for search engine presence and positioning. The method 500 includes the following steps:
(a) Providing a management engine 520.
(b) Configuring 510 rule data collection 30 for including SEO operations.
(c) Transferring 530 rule data collection 30 to multiple websites as determined by an operator, an administrator, or the management engine 80 itself.

### A Method Embodiment for Rule Data Collection Application

A method 600 for rule-implementing application is illustrated in the flow chart of FIG. 8. Method 600 includes the following steps:
(a) Providing 605 a rule-implementing application 60.
(b) Receiving 610 rule data collection 30.
(c) Applying 640 rule data collection 30 on the website pages 94 and 98 to get optimized pages 99.

The optimized pages 99 may be submitted to a requesting client and/or stored in the website for future use.

Receiving 610 Rule data collection 30 include the action of moving rule data collection from their creation place (management side) to their destination place (website side) for both the case that the action is initiated and/or managed from the management side and the case that the action is initiated and/or managed from the website side.

### A Method Embodiment for Effecting SEO Operations to Web Pages on Web Servers

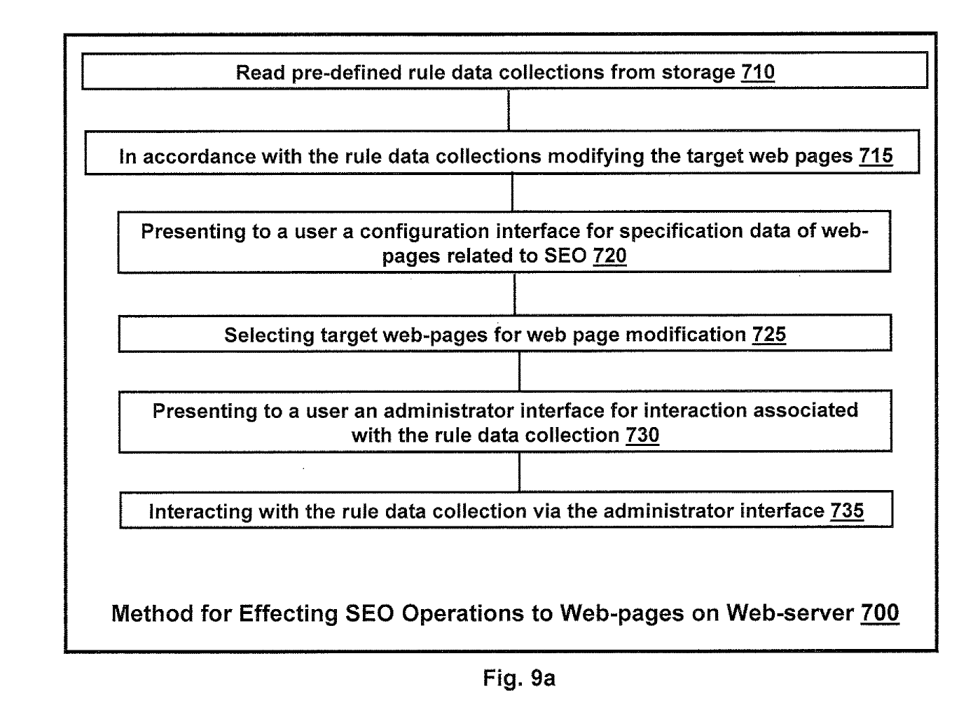

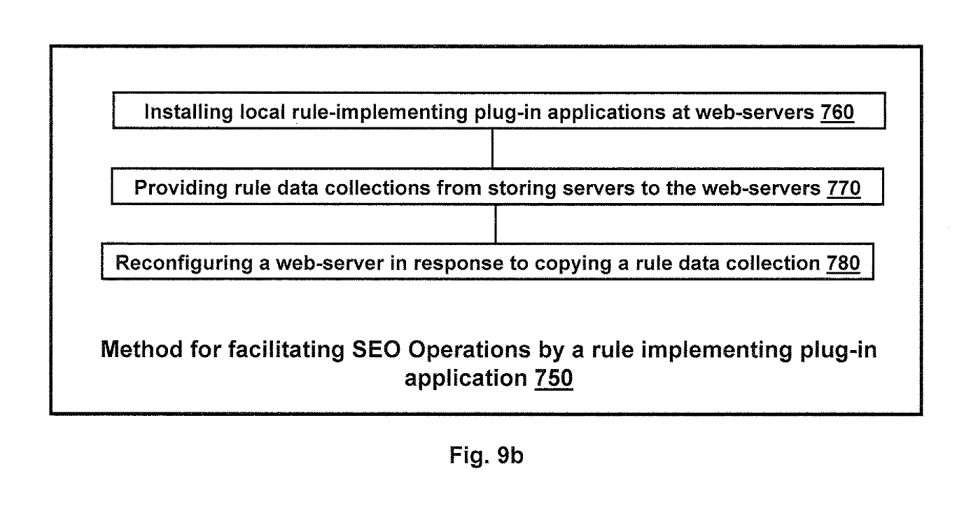

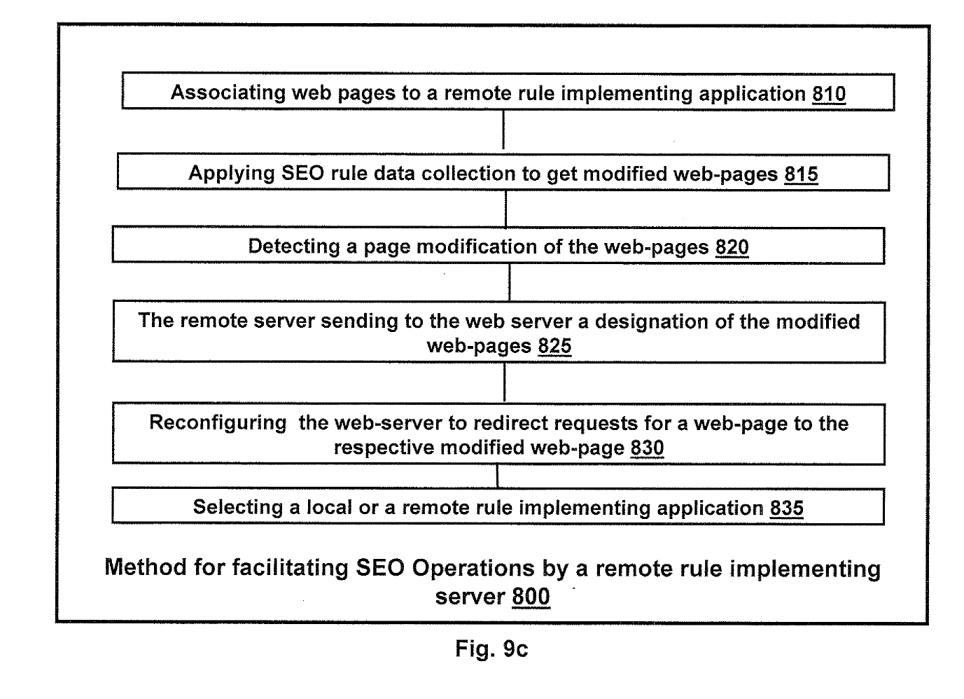

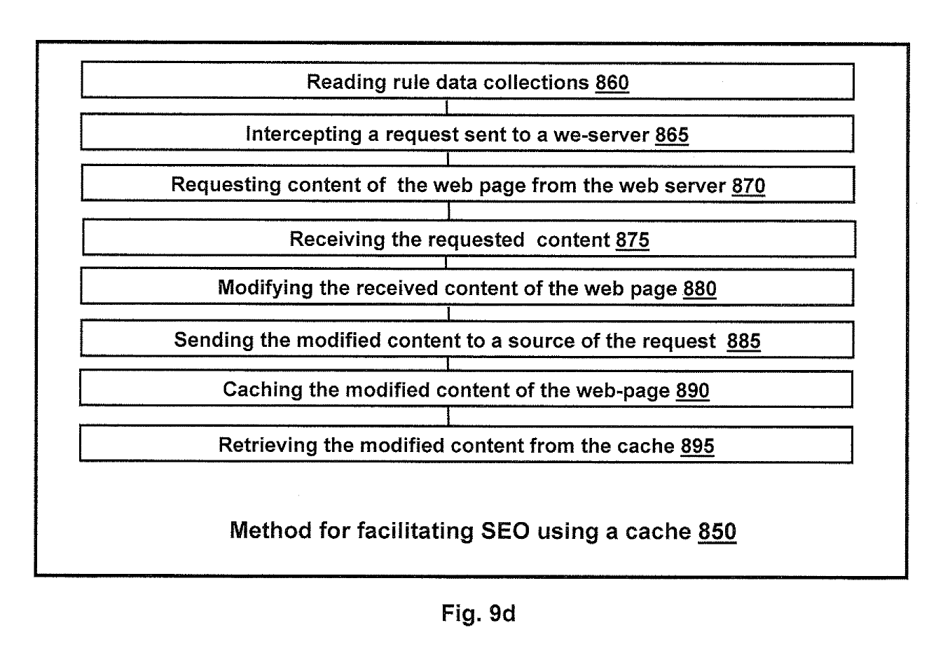

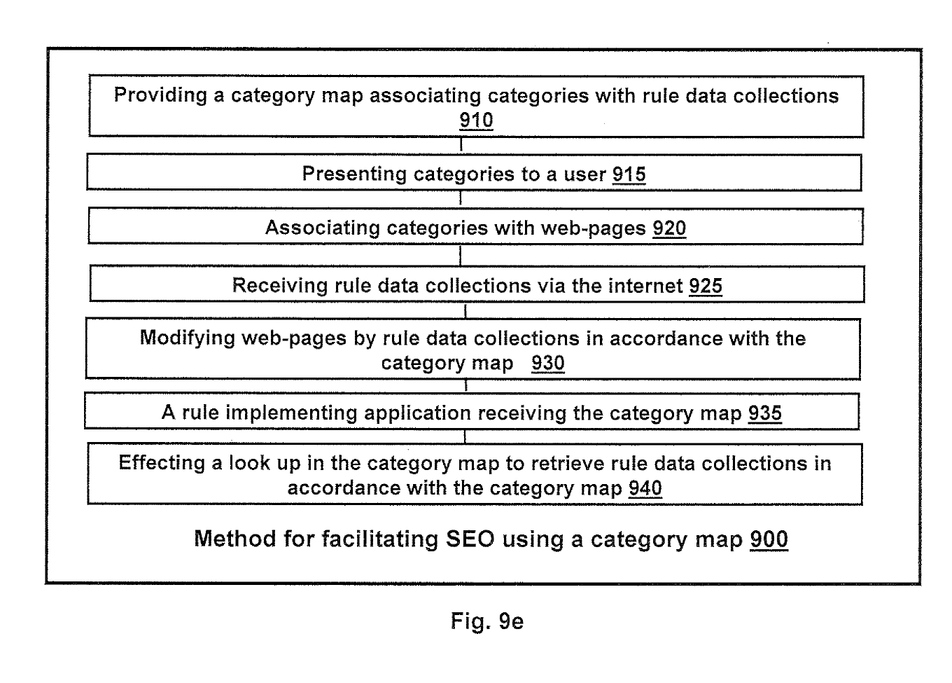

Referring now to the flow chart of FIG. 9a, it depicts the steps of a method 700 of effecting search engine optimization (SEO) operations to multiple target web pages residing on multiple target web servers. The method includes the step 710 of reading from a memory a pre-defined rule data collection specifying content transformations of web pages, and the step 715 of modifying the target web pages. The effecting of the SEO operations is done by using computer processors executing computer-readable codes for automatically carrying out the method. For example, the computer processor of a web server 45 has a rule implementing plug-in application 60, which applied rule data collection 30.

In some embodiments, the computer processor resides in a page-modification machine 107 linked to the target web servers 45a of FIG. 1d by a computer network, a LAN (local area network) computer network or the internet, for example.

In some embodiments, the processor of web server 45 is linked via a computer network to an independent proxy server 66a, or to a proxy 66b residing in a SEO management web server 20 or has a proxy 66c therein. The proxies 66a, 66b and 66c are configured for storing modified or optimized pages 99 and for providing the stored modified pages upon a request from a page client 50 for web pages associated with the stored modified pages 99. Also, the proxies 66a, 66b and 66c may initiate preparation of modified web-pages in advance, without any request by a page client for a specific web-page. Thus, upon getting such request the proxies 66a, 66b and 66c may provide the requested web-pages as SEO modified web-pages 99, thus preventing work overloads in hours of high traffic.

In some embodiments, the content transformations includes web-page-transforming instruction like an instruction to inject links or meta-tags, to modify a web page title, or to inject a visible text or a hidden text.

In some embodiments, method 700 further includes the step 720 of presenting to a user a configuration interface 71 for providing specification data of a target web-page relating to SEO and step 725 of selecting the target pages from a plurality of target pages in accordance with the specification data.

Method 700 may also include the step 730 of presenting to a user an administrator interface 70 for step 735 of interacting with a rule data collection 30.

### A Method for Facilitating SEO Operations by a Rule Implementing Application

FIG. 9b illustrates a flow chart for a method 750 of facilitating SEO of target web pages residing in target web servers 45 by a rule implementing application 60 residing as a local plug-in application in each of the target web-servers 45. Method 750 includes the step 760 of installing the local rule-implementing plug-in application 60 at the web-servers 45, the step 770 of providing a pre-defined rule data collection from rule storing servers, via a computer network, to the web-servers, and the step 780 of reconfiguring the web-server 45 by executing code of the rule implementing plug-in application to modify the target web pages in accordance with the provided rule data collection 30.

In some embodiments, the rule data collections are provided to multiple web servers. In the example of FIG. 1b, a first target web server 45 to which a first rule data collection 30a is provided, and a second target web server 45b to which a second rule data collection 30b different from the first rule data collection 30a is provided.

For a given web-server 45, the providing 770 of rule data collection 30 may be carried out in response with a rules-update request received from the rule-implementing plug-in application 60 residing on web-server 45. Alternatively, the providing 770 may be carried out in response to a user-generated request from page client 50, or in response to installing rule-implementing plug-in applications 60.

### A Method for Facilitating SEO Operations by a Remote Rule Implementing Server

Referring now to the flow chart of FIG. 9c, a method 800 of facilitating SEO includes the step 810 of associating target web pages residing on a web server 45 to a rule implementing application 60, and the step 815 of applying pre-defined SEO rules to modify the associated target web pages and to generate modified web pages 99 by the rule implementing application 60. The rule implementing application may be a remote application 60b residing on a remote rule implementing web server 107 linked to the web serve 45a r via a computer network, as depicted in FIG. 1d. The associating 810 of target web pages residing on a web server 45a to the rule implementing application 60b is done by sending a designation of the target web pages the remote rule implementing server 107 via the computer network.

In some embodiments, method 800 further includes the step 820 of detecting of a page modification of the target web pages. In response, it is provided 825 to the web server 45a a designation of the modified web pages 99 by the rule implementing web server 107. The web server may be reconfigured 830 to respond to requests for the designated target web pages by providing the modified web pages 99 or a reference thereto. The designation of the target pages may be done using a link or a uniform resource locator (URL) associated with the target pages.

In some embodiments, a local rule implementing application 60a is residing in a web-server 45a, as depicted in the block diagram of FIG. 1d. Method 800 further includes the step 835 of selecting an appropriate rule implementing application for modifying the one or more web-pages. In case remote rule implementing application 60b is selected a first routine is applied. The first routine includes sending to the a remote rule implementing server 107 a designation of the target web pages 94 and 98, modifying the web-pages 94 and 98 and responding to requests to the web-pages 94 and 98 by designation of modified web-pages 99. In case the local rule implementing application 60a is selected a second routine is applied. The second routine includes locally modifying the target web-pages 94 and 98 by local rule implementing application 60a in accordance with rule data collections 30 residing at the web server 45a. The selecting 835 of an appropriate rule implementing application may be done in accordance with workload on the remote rule implementing server 107 and on the web-server 45a. The workload may be either detected or estimated.

### A Method for Facilitating SEO Operations Using a Cache

FIG. 9d presents a flow chart of a method 850 for facilitating SEO. Method 850 includes the step 860 of reading from a memory pre-defined rule data collections 30 for transforming web page 94 and 98, the step 865 of intercepting a request for a web page 94 or 98 sent via a network to a web server 45, requesting content of the web page 94 or 98, the step 870 of requesting content of the web page 94 or 98 from web server 45, the step 875 of receiving the requested content, the step 880 of modifying the received content of the web page, and the step 885 of sending the modified content of the web page to a page client which has requested it.

Method 850 may further include the step 890 of caching the modified content of the web page in a cache 63a, 63b or 63c. Later, on intercepting 865 a request for web page 94 or 98 sent via the network to the web server 45, the modified content of the web page is retrieved 895 from cache 63a, 63b or 63c, respectively. The method may be carried out on the web server 45 of FIG. 1a or on a different server 107 (FIG. 1d) or 20 associated to the web server 45 via a network.

### A Method for Facilitating SEO Operations Using a Category Map

Referring now to the flow chart of FIG. 9e, a method 900 is provided for facilitating SEO using a category map 64. Method 900 includes the step 910 of providing a category map 64 associating search engine optimization categories to rule data collections 30, the step 915 of presenting a plurality of search engine optimization categories to a user, the step 920 of associating by the user target web pages 94 and 98 with categories, the step 925 of receiving rule data collection 30 via the internet, and the step 930 of modifying the target web pages 94 and 98 according to rule data collections 30 associated by the category map 64 with the selected categories.

Method 900 may further include the step 935 of receiving by a search engine optimization plug-in application 60, executing at a host web server 45, a description of the selected categories, and the step 940 of effecting a look up in the category map 64 to retrieve rule data collections corresponding to the selected categories. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A method for optimizing two or more pages of two or more websites for search engine presence and positioning, the method comprising:
(a) configuring one or more rule data collections for application of one or more search engine optimization operations on website pages, wherein at least one rule data collection includes at least one search engine optimization operation appropriate for at least two websites;
(b) transferring said at least one rule data collection to said at least two websites; and
(c) applying at least said at least one search engine optimization operation of said at least one rule data collection on two or more pages of said at least two websites;
thereby getting two or more optimized pages of two or more websites, of which at least two pages of two websites being effected by said at least one rule data collection.

2. The method of claim 1 wherein the method further includes the step of:
providing a management engine operative for said configuring one or more rule data collection.

3. The method of claim 1 wherein the method further includes the step of:
providing a rule implementing application operative for the application of search engine optimization operations of rule data collection.

4. The method of claim 1 wherein the method further comprises the step of:
storing data associated with said one or more optimized pages.

5. The method of claim 1, wherein the method further includes the step of:
defining one or more page selection criteria;
wherein applying at least one search engine optimization operation of an rule data collection on a certain page depends on compliance of said certain page with certain page selection criterion of said one or more page selection criteria.

6. The method of claim 1 wherein said one or more search engine optimization operations include one or more page editing actions, wherein at least one page editing action is selected from the group of actions consisting of adding a first element to a first part of said page, changing a second element in a second part of said page, and changing a parameter of said page.

7. The method of claim 6 wherein:
(i) at least one element of said first element and said second element is one element of the group of elements consisting of a link, a link index, a link pointer, a piece of text, a keyword, a piece of meta data, and a layout; and
(ii) at least one part of said first part of said page and said second part of said page is one part of the group of parts consisting of an header, a footer, a meta data part, and a body of a page.

8. The method of claim 1 wherein the method further includes the steps of:
(b′) receiving at least one page request from at least one page client; and
(b″) generating a page responsive to said at least one page request;
wherein the application of search engine optimization operations is performed on the generated pages, and the optimized pages are submitted to the page client.

9. The method of claim 8 wherein said generating a page is copying at least part of a static page from a database associated with a website having the requested page.

10. The method of claim 8 wherein said generating a page is integrating a dynamic page from data items available in one or more databases, said integrating a dynamic page being in accordance with said at least one page request.

11. The method of claim 8 wherein said at least one page client is one of a search engine crawler and a web browser.

12. A method for optimizing website pages for search engine presence and positioning, the method comprising:
(a) configuring one or more rule data collection for application of one or more search engine optimization operations on website pages;
(b) defining one or more page selection criteria; and
(c) applying said search engine optimization operations of at least one rule data collection on certain one or more website pages upon said certain one or more pages being in compliance with the page selection criteria;
thereby getting one or more optimized pages.

13. The method of claim 12 wherein at least one of said page selection criteria is associated with a certain rule data collection.

14. The method of claim 12 wherein said page selection criteria include compliance with one of:
(A) certain business category of a website;
(B) certain geographical properties of a website;
(C) certain number of links allowed in a certain page part;
(D) certain identity of a parent website;
(E) certain industry category of a website;
(F) certain page extension; and
(G) certain business category of a website page.

15. A method for providing one or more rule data collection, the rule data collection being usable for application of one or more search engine optimization operations on two or more pages of two or more websites, the method comprising:
(a) configuring one or more rule data collections for including one or more search engine optimization operations, at least one rule data collection including at least one search engine optimization operation appropriate for at least two websites; and
(b) transferring at least said at least one rule data to two or more websites.

16. The method of claim 15 wherein the method further includes the step of:
providing a management engine operative for interaction with an administrator regarding rule data collection and for configuring Rule data collection.

17. A program storage device readable by a computer, tangibly embodying a program of instructions executable by the computer to perform the method of claim 15.

18. A system for optimizing one or more pages of one or more websites for search engine presence and positioning, the system comprising:
(a) a management engine operative for configuring one or more rule data collections to include one or more search engine optimization operations;
(b) a repository for storing said one or more rule data collection; and
(c) a rule implementing application operative to apply at least one of said one or more search engine optimization operations of said one or more rule data collections on website pages;
wherein the management engine configures said rule data collections, the rule data collections are stored in said rule data collection database and transferred to one or more appropriate websites, and the rule implementing application applies the search engine optimization operations of the transferred rule data collection on appropriate website pages, thus getting optimized pages.

19. The system of claim 18 wherein the system further includes an administrator interface operative for interaction of an operator with the management engine, wherein said interaction is associated with search engine optimization operations to be included in said rule data and with application of certain rule data on certain website pages.

20. The system of claim 18 wherein the system further includes a page generator operative for receiving a page request and generate a responsive page.

21. A system for making rule data collection for optimizing two or more pages of two or more websites for search engine presence and positioning, the system comprising:
(a) a management engine operative for configuring rule data collections to include one or more search engine optimization operations, wherein at least one rule data collection including at least one search engine optimization operation appropriate for at least two websites; and
(b) a repository operative for storing the rule data collections and for transferring at least said at least one rule data collection to said at least two websites.

22. The system of claim 21 wherein the system further includes an administrator interface operative for interaction of an operator with the management engine, wherein said interaction may be associated with search engine optimization operations to be included in said rule data collections and with application of certain rule data collections on certain website pages.

23. A method of effecting search engine optimization operations to two or more target web pages residing on two or more target web servers, the method comprising the steps of:
a) reading from a memory a pre-defined rule data collection specifying one or more content transformations of two or more web pages; and
b) in accordance with said one or more content transformations, modifying the target web pages residing on the two or more target web servers,
wherein the effecting of the search engine optimization operations being by using one or more computer processors executing one or more computer-readable codes for automatically carrying out the steps.

24. The method of claim 23 wherein at least one of said one or more computer processors resides in a page-modification machine linked to the one or more target web servers by a computer network, and said computer network is one network of a local-area computer network and a wide-area computer network.

25. The method of claim 23 wherein at least one processor is linked via a computer network to a proxy, and the proxy is configured for storing modified pages and for providing the stored modified pages upon a request from a page client for web pages associated with the stored modified pages.

26. The method of claim 23 wherein said one or more content transformations includes at least one web-page-transforming instruction selected from the group of instructions consisting of:
i) an instruction to inject one or more links;
ii) an instruction to inject one or more meta-tags;
iii) an instruction to modify a web page title; and
iv) an instruction to inject a visible text or a hidden text.

27. The method of claim 23 wherein the method further comprises:
d) selecting the target pages from a plurality of target pages, wherein only the selected target pages are subjected to the web page modification.

28. The method of claim 27 wherein the method further comprises the step of:
c) presenting to a user a configuration interface for providing specification data of a target web-page relating to search engine optimization,
wherein said selecting is carried out according to said page specification data.

29. The method of claim 23 wherein the method is applied to a plurality of target web pages such that:
(i) a first web page of the plurality of target web pages is subjected to a first pre-defined transformation specified by a first data sub-set of the pre-defined rule data collection; and
(ii) a second web page of the plurality of target web pages is subjected to a second pre-defined transformation defined by a second data sub-set of the pre-defined rule data collection, said second pre-defined transformation is different from said first pre-defined transformation, said second data sub-set is different from said first data sub-set.

30. The method of claim 23 wherein the method further comprises the steps of:
i) presenting to a user an administrator interface for interaction associated with a rule data collection; and
ii) interacting with the rule data collection via the administrator interface.

31. A method of facilitating search engine optimization of one or more target web pages residing in one or more target web servers by a rule implementing application residing as a local plug-in application in each of the target web-servers, the method comprising:
(a) providing a pre-defined rule data collection from one or more rule storing servers, via a computer network, to the web-servers; and
(b) for at least one of the web-servers, reconfiguring the web-server by:
in response to the providing of the rule data collection to the web-servers, executing code of the rule implementing plug-in application by the web server to modify one or more of the target web pages in accordance with the provided rule data collection.

32. The method of claim 31 further comprising:
installing the local rule-implementing plug-in application at the one or more web-servers.

33. The method of claim 31 wherein the rule data collection are provided to multiple web servers including a first target web server to which a first rule data collection is provided and a second target web server to which a second rule data collection different from the first rule data collection is provided.

34. The method of claim 31 wherein for a given web-server selected from the one or more web-servers, the rule data collection providing is carried out in response to a rules-update request received from the rule-implementing plug-in application residing on the given web-server.

35. The method of claim 31 wherein the providing is carried out in response to a user-generated request.

36. The method of claim 31 wherein the providing is carried out in response to installing one or more rule-implementing plug-in applications.

37. A method of facilitating search engine optimization, the method comprising:
a) associating one or more target web pages residing on a web server to a rule implementing application; and
b) said rule implementing application applying one or more pre-defined search engine optimization rules to modify the associated target web pages and to generate modified web pages.

38. The method of claim 37 wherein said rule implementing application is a remote application residing on a remote rule implementing web server linked to said web server via a computer network, and said associating one or more target web pages residing on a web server to said rule implementing application is done by sending a designation of one or more target web pages residing on said web server to said remote rule implementing server via the computer network.

39. The method of claim 38 further comprises:
d) providing by the rule implementing server to said web server, a designation of said modified web pages.

40. The method of claim 39 further comprises:
e) in response to receiving of said designation of said modified web pages, reconfiguring said web server to respond to requests for said designated target web pages by providing said modified web pages or a reference thereto.

41. The method of claim 39 wherein the method further includes:
c) detecting of a page modification of one or more of the target web pages, wherein said sending a designation of said modified web pages is carried out in a response to said detecting.

42. The method of claim 38 wherein said designation of one or more target pages is done using a link or a uniform resource locator associated with the target pages.

43. The method of claim 38 wherein a local rule implementing application is residing in a certain web-server having one or more web-pages and the method further includes the step of:
f) selecting an appropriate rule implementing application for modifying said one or more web-pages,
wherein in case said remote rule implementing application is selected a first routine is applied, said first routine includes sending to the a remote rule implementing server a designation of said one or more target web pages, modifying the web-pages and responding to requests to the web-pages by designation of modified web-pages, and wherein in case said local rule implementing application is selected a second routine is applied, said second routine includes locally modifying the one or more target web-pages by the local rule implementing application in accordance with rule data collections residing at the web server.

44. The method of claim 43 wherein said selecting an appropriate rule implementing application is done in accordance with workload on at least one of said remote rule implementing server and said web-server.

45. The method of claim 37 wherein the method further includes the step of:
c) receiving at least one rule data collection configured to include one or more search engine optimization operations,
wherein said rule implementing application applies said one or more search engine optimization operations by implementing said at least one rule data collection.

46. A program storage device readable by a computer, tangibly embodying a program of instructions executable by the computer to perform the method of claim 37.

47. The method of claim 45 wherein the method further includes the steps of
(b′) receiving at least one page request from at least one page client; and
(b″) generating a page responsive to said at least one page request;
wherein the application of search engine optimization rules is performed on the generated pages, and the optimized pages are submitted to the page client.

48. A method of facilitating search engine optimization, the method comprising:
a) reading from a memory one or more pre-defined rule data collections for transforming one or more web page, each of the rule data collections specifying one or more content transformations;
b) intercepting a request for a web page sent via a network to a web server;
c) requesting content of said web page from said web server;
d) receiving content of said web page from said web server;
e) in accordance with said one or more content transformations, modifying the received content of said web page; and
f) sending the modified content of the web page to a source of the intercepted web page request.

49. The method of claim 48 further comprising:
g) caching said modified content of said web page in a cache;
and on intercepting a request for said web page sent via said network to said web server
h) retrieving said modified content of said web page from said cache.

50. The method of claim 49 wherein a decision on retrieving said modified content from said cache rather than modifying a requested web page is based on workloads.

51. The method of claim 48 wherein the method is carried out on said web server or on a different server associated to said web server via a network.

52. A method of facilitating search engine optimization, the method comprising:
a) providing a category map associating a one or more search engine optimization categories to one or more rule data collections;
b) presenting a plurality of search engine optimization categories to a user; and
c) said user associating one or more target web pages with one or more categories selected of the presented categories;
d) modifying said one or more target web pages according to one or more rule data collections associated by said category map with the selected categories.

53. The method of claim 52 wherein the method further includes:
i) receiving by a search engine optimization plug-in application executing at a host web server a description of the selected categories; and
ii) effecting a look up in said category map to retrieve rule data collections corresponding to the selected categories.

54. The method of claim 52 wherein the method further includes receiving said one or more rule data collections via a wide-area computer network.
